(19) United States
(12) Patent Application Publication
(10) Pub. No.: US 2026/0087962 A1
(43) Pub. Date: Mar. 26, 2026

(54) Content-Addressable Control Circuitry for Electronic Display

(71) Applicant: Apple Inc., Cupertino, CA (US)

(72) Inventors: Pablo Moreno Galbis, Burlingame, CA (US); Arjunsimha Chaturbhuj, San Jose, CA (US); Kanghoon Jeon, San Jose, CA (US); Bilin Wang, San Jose, CA (US); Derek K Shaeffer, Redwood City, CA (US); Hopil Bae, Palo Alto, CA (US); Kameshwar Kaushik Chavali, San Jose, CA (US); Ali RostamPisheh, Santa Clara, CA (US); Nikhil Acharya, Mountain View, CA (US); Stanley B Wang, Cupertino, CA (US); Chun-Yao Huang, San Jose, CA (US); Dongwon Kwon, Cupertino, CA (US); Henry C Jen, Los Altos, CA (US); Xiang Lu, Saratoga, CA (US); Rajesh Velayuthan, Pleasanton, CA (US); Bruce C Gamache, Boulder, CO (US); Marko Aleksic, Mountain View, CA (US)

(21) Appl. No.: 19/341,947

(22) Filed: Sep. 26, 2025

Related U.S. Application Data
(60) Provisional application No. 63/699,721, filed on Sep. 26, 2024.

(51) Int. Cl. G09G 3/20; G09G 3/32

(52) U.S. Cl. CPC G09G 3/2044; G09G 3/32; G09G 2300/08; G09G 2310/0297; G09G 2310/08; G09G 2330/021; G09G 2360/00

(57) ABSTRACT

Content-addressable memory-in-display (CAMiD) electronic displays and circuitry are provided. An electronic display may include a pixel active array and content-addressable memory configured to selectively control the pixel active array.

### CROSS-REFERENCE TO RELATED APPLICATION

This application claims priority to U.S. Provisional Application No. 63/699,721, filed Sep. 26, 2024, which is incorporated by reference herein in its entirety for all purposes.

### SUMMARY

The present disclosure relates to a content-addressable memory-in-display (CAMiD) architecture for a pulsed electronic display, such as for pulse width modulation (PWM) in micro light emitting diode (μLED) electronic displays.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Numerous electronic devices—such as computers, mobile phones, portable media devices, tablets, televisions, virtual-reality headsets, and vehicle dashboards, among many others—include electronic displays. To display an image, an electronic display may control the light emission of its display pixels based on corresponding image data for each display pixel. By emitting light in various gray levels (pixel brightness values) using display pixels of different colors according to the image data, the electronic display may display an image.

Some electronic displays use micro light emitting diodes (uLEDs). These devices emit light when a current flows through them. They are advantageous to use in applications that benefit from very high brightness, very efficient light emission and reliable and stable light emission devices. For efficiency and stability purposes, uLEDs are typically driven at a constant current for that particular uLED type, size and color. Hence, in a uLED electronic display, the gray level of any particular pixel is determined by how long the uLED is driven relative to how long the uLED is not driven, for example, with a Pulse Width Modulation (PWM) signal. The PWM signal may be so fast that the human eye does not see individual pulses, but rather sees the average amount of light that is emitted.

Rather than use PWM controller circuits distributed throughout the pixel active area, which may take up significant area, a content-addressable memory-in-display (CAMiD) architecture may enable power-and area-efficient PWM. The CAMiD is a memory located outside of the pixel active area containing the binary value of the gray level corresponding to each display pixel in the pixel active area. The CAMiD has a small comparator corresponding to each display pixel. A common timing circuit to memory for many display pixels may start counting once the emission begins. The comparator corresponding to each display pixel will compare the binary value of the gray level contained by the memory with a gray value provided by the timing circuit. If there is a match, it triggers sending a signal down a column driver circuit to cause that display pixel in the pixel active area to turn off. This operation consumes negligible power.

There are numerous ways to implement the column drivers and comparators of the CAMiD architecture. By way of example, the column drivers may use dynamic driving using pull-down transistors, static driving using AND or NAND gates, or may be multiplexer-based. Comparators may be dynamic OR-based comparators, dynamic AND-based comparators, static comparators, low-area AND-based comparators, and/or comparators with a “bigger than” function to separate gray levels to be emitted at different times.

The electronic display may be so fast that a single frame of image data may be displayed on the electronic display over a series of subframes. Since multiple subframes are displayed over the course of displaying one image frame, subframe-based dithering may be used to achieve a greater brightness resolution resulting in more possible colors. Dithering relates to, for a particular constant image to be shown to the viewer, alternating the gray level value of a pixel between two consecutive values for the eye to average and represent a middle gray level value. For example, to achieve an equivalent gray level of 2.5 at a pixel, the pixel may alternatingly display a gray level of 2 for a first subframe and a gray level of 3 for a second subframe.

Implementing dithering between subframes with a CAMiD memory may involve special logic, since the data in the display may not be updated between subframes that make up each image frame. The CAMiD architecture thus may interpret that image data in a way that causes gray the level in each subframe to change only for the desired pixels. A variety of approaches to subframe dithering are provided. These include column-level dithering, which trades read speed for area, and CAMiD pixel-level dithering, which trades area for read speed. In column-level dithering, the core cell of the CAMiD memory containing the pixel data and comparator are unchanged. Instead, for each gray level, multiple values of gray level are read instead of one. In each column, a circuit may store the output of those multiple reads and decide if the pixel in the pixel active area should be turned off or not. In pixel-level dithering, logic circuitry on the CAMiD core cell (not in the pixel active array) may determine whether to apply subframe dithering. For example, comparators may be combined with other logic and/or flip-flops or latches so that the output of the CAMiD is different for a particular gray level in different subframes. In these ways, the CAMiD architecture may be used to achieve efficient subframe dithering.

### BRIEF DESCRIPTION OF THE DRAWINGS

Various aspects of this disclosure may be better understood upon reading the following detailed description and upon reference to the drawings in which:

FIG. 1 is a block diagram of an electronic device with an electronic display;

FIG. 2 is a front view of a handheld device representing an example of the electronic device of FIG. 1;

FIG. 3 is a front view of another handheld device representing another example of the electronic device of FIG. 1;

FIG. 4 is a perspective view of a notebook computer representing an example of the electronic device of FIG. 1;

FIG. 5 illustrates front and side views of a wearable electronic device representing another example of the electronic device of FIG. 1;

FIG. 6 is a block diagram illustrating circuitry to perform pulse width modulation (PWM) to control pixels of an electronic display;

FIG. 7 is a timing diagram of the pulse width modulation (PWM) of FIG. 6;

FIG. 8 is a block diagram of a content-addressable memory-in-display (CAMiD) electronic display;

FIG. 9 is a block diagram of the CAMiD architecture;

FIG. 10 is a block diagram of a pixel active array of the CAMiD electronic display;

FIG. 11 is a circuit diagram of a dynamic column driver of the CAMiD architecture;

FIG. 12 is a circuit diagram of a static column driver of the CAMiD architecture;

FIG. 12A is a circuit diagram of a serial CMOS-multiplexer column driver of the CAMiD architecture;

FIG. 12B is a circuit diagram of transistors that may make up part of the serial CMOS-multiplexer column driver of FIG. 12A;

FIG. 12C is a multi-row view of the serial CMOS-multiplexer column driver of FIG. 12A;

FIG. 12D is a multi-row view of the serial CMOS-multiplexer column driver of FIG. 12A that uses inverters rather than digital buffers;

FIG. 13 is a circuit diagram of a digital multiplexer-based column driver of the CAMiD architecture;

FIG. 14 is a circuit diagram of a dynamic OR-based comparator of the CAMiD architecture;

FIG. 15 is a circuit diagram of a dynamic AND-based comparator of the CAMiD architecture;

FIG. 16 is a circuit diagram of a static comparator of the CAMiD architecture;

FIG. 17 is a circuit diagram of another static comparator of the CAMiD architecture;

FIG. 18 is a circuit diagram of a dynamic low-area AND-based comparator of the CAMiD architecture;

FIG. 19 is a circuit diagram of a comparator of the CAMiD architecture with a “bigger than” function;

FIG. 20 is a table representing examples of subframe 1-bit dithering that may be carried out using the CAMiD electronic display;

FIG. 21 is a timing diagram of the examples of subframe 1-bit dithering of FIG. 20;

FIG. 22 is a circuit diagram of column-level subframe 1-bit dithering circuitry;

FIG. 23 is a timing diagram of the examples of subframe 1-bit dithering of FIG. 20 implemented using the column-level subframe 1-bit dithering circuitry of FIG. 22;

FIG. 24 is a timing diagram of the examples of subframe 1-bit dithering of FIG. 20 implemented using pixel-level subframe 1-bit dithering circuitry;

FIG. 25 is a circuit diagram of pixel-level subframe 1-bit dithering circuitry including multiple comparators;

FIG. 26 is a circuit diagram of another example of pixel-level subframe 1-bit dithering circuitry including multiple comparators;

FIG. 27 is a circuit diagram of pixel-level subframe dithering circuitry using a carry-bit approach;

FIG. 28 is a circuit diagram of pixel-level subframe dithering circuitry using a carry-bit approach for 2-bit or higher dithering with multiple comparators;

FIG. 29 is a circuit diagram of pixel-level subframe dithering circuitry using a carry-bit approach for 2-bit or higher dithering where the carry bit is calculated with dynamic logic in advance;

FIG. 30 is a circuit diagram of dynamic logic that may be used to calculate the carry bit for 2-bit or higher dithering;

FIG. 31 is a circuit diagram of flexible pixel-level subframe dithering circuitry that may selectively operate without dithering, with 1-bit dithering, or with 2-bit dithering;

FIG. 32 is another circuit diagram of logic that may be used to calculate the carry bit for the flexible pixel-level subframe dithering circuitry of FIG. 31;

FIG. 33 is a circuit diagram of 1-bit pixel-level subframe dithering circuitry that uses a latch to perform dithering; and FIG. 34 is a circuit diagram of 2-bit pixel-level subframe dithering circuitry that uses a latch to perform dithering.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

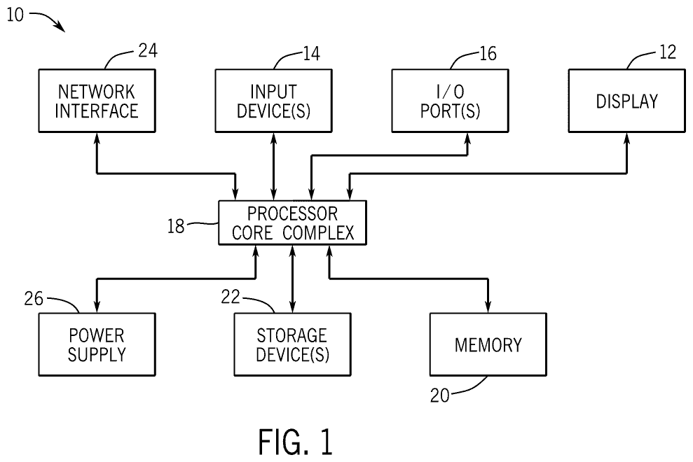

An electronic device 10 including an electronic display 12 is shown in FIG. 1. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, and a power source 26 (e.g., power supply). The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

The electronic display 12 may include a display panel with an array of display pixels. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one color component (e.g., red, green, or blue for an RGB pixel arrangement or red, green, blue, or white for an RGBW pixel arrangement).

The electronic display 12 may display an image by controlling light emission from its display pixels based on image data associated with corresponding display pixels in the image. In some embodiments, image data may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display frames based on image data generated by the processor core complex 18, or the electronic display 12 may display frames based on image data received via the network interface 24, an input device, or an I/O port 16.

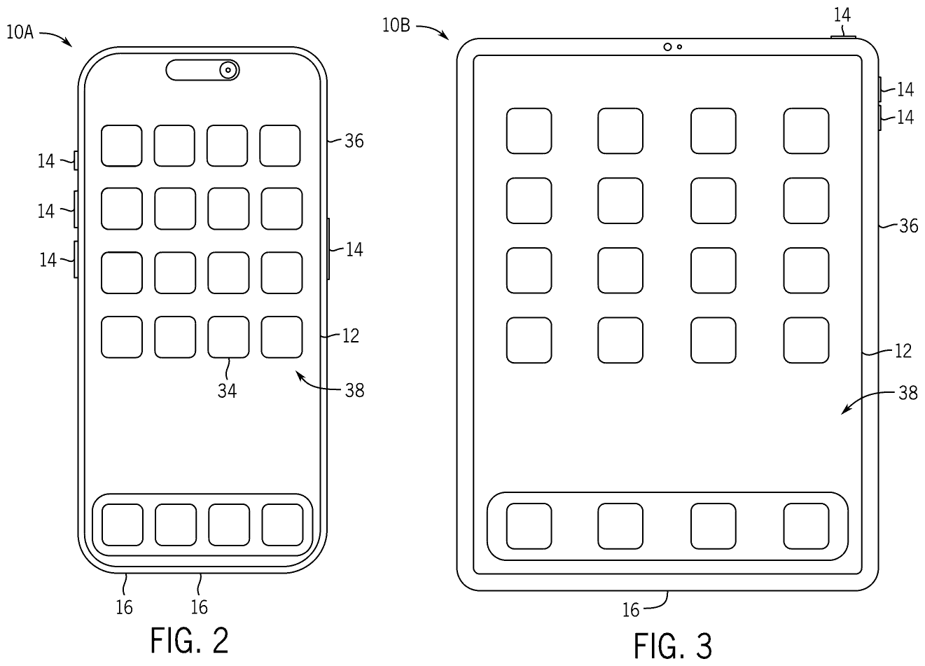

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as an IPHONE® model available from Apple Inc.

The handheld device 10A includes an enclosure 30 (e.g., housing). The enclosure 30 may protect interior components from physical damage or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

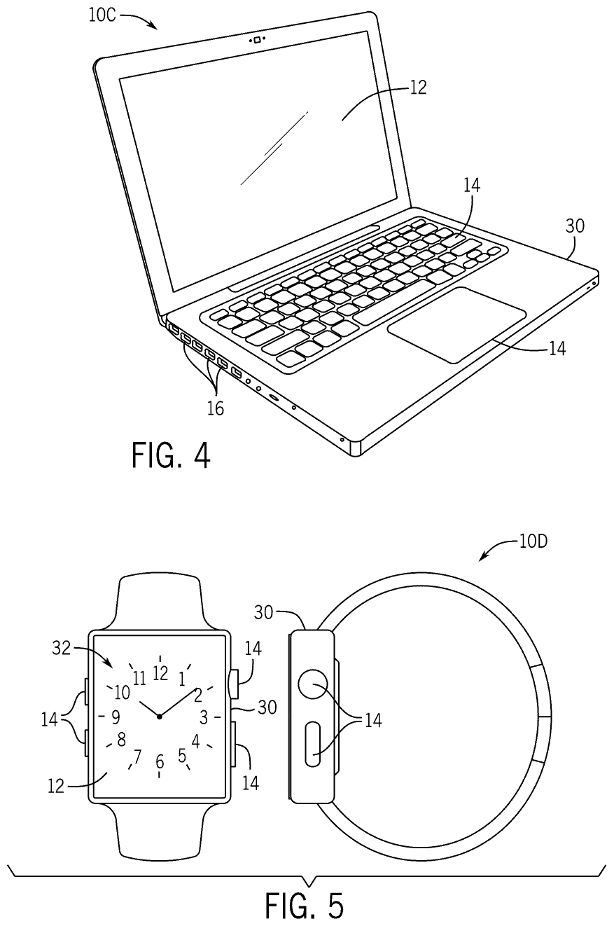

Another example of a suitable electronic device 10, specifically a tablet device 10B, is shown in FIG. 3. The tablet device 10B may be an IPAD® model available from Apple Inc. A further example of a suitable electronic device 10, specifically a computer 10C, is shown in FIG. 4. For illustrative purposes, the computer 10C may be a MACBOOK® or IMAC® model available from Apple Inc. Another example of a suitable electronic device 10, specifically a watch 10D, is shown in FIG. 5. For illustrative purposes, the watch 10D may be an APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

The electronic display 12 may be a pulsed electronic display that operates using micro-LEDs. As mentioned above, in a uLED electronic display, the gray level of any particular pixel is determined by how long the uLED is driven relative to how long the uLED is not driven, for example, with a Pulse Width Modulation (PWM) signal. The PWM signal may be so fast that the human eye does not see individual pulses, but rather sees the average amount of light that is emitted.

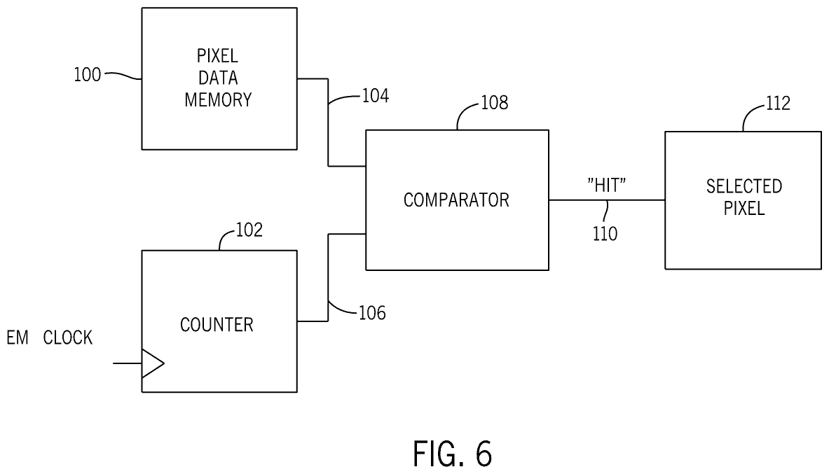

FIG. 6 illustrates a principle of operation of the electronic display 12, representing how each display pixel of the electronic display 12 is driven to display a certain brightness level using PWM pulses. For each display pixel of the electronic display 12, image data may be stored into a pixel data memory 100 associated with that display pixel. For example, the image data may be a binary number that corresponds to a gray level (brightness level). The term “gray level” refers to the brightness level that a pixel is programmed to display. The gray level may have any suitable bit depth. When the gray level has a bit depth of 8 bits, the gray level may be a brightness level between 0 and 255. The combination of different gray levels with different colored pixels can produce a vast array of different colors and images on the electronic display.

A digital counter 102 may increment a counter based on an emission clock signal (EM CLOCK). The pulses of the emission clock signal may correspond to all the possible gray levels that can be represented by a PWM signal to a display pixel. The pixel data memory 100 may output the value of the image data that it has stored, while the counter 102 may output a digital counter signal 106 based on edges of the emission clock signal (EM CLOCK). The signals 104 and 106 may enter a comparator 108 that compares these values. When the comparator 108 determines that the signals 104 and 106 are equal, this means that the pulse width defined by the emission clock signal (EM CLOCK) has reached a value equal to the gray level defined in the pixel data memory 100. As such, the comparator 108 may output a “hit” signal 110. The “hit” signal 110 may be routed to the display pixel to cause the display pixel to be turned off. The longer the selected display pixel is allowed to remain on (is not driven “off” based on the “hit” signal), the greater the amount of light that will be perceived by the human eye as originating from the display pixel.

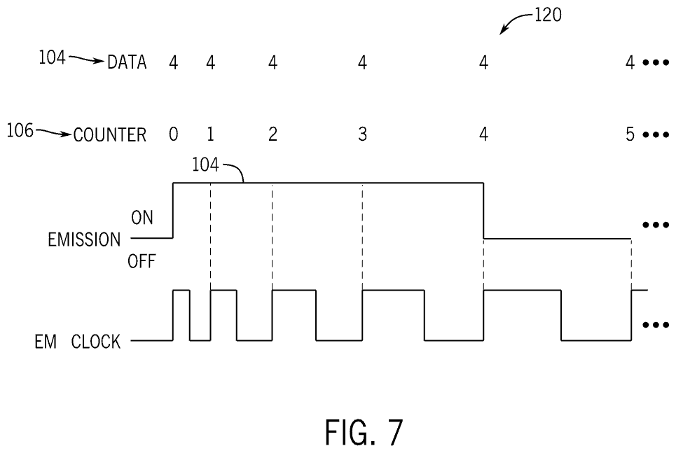

A timing diagram 120, shown in FIG. 7, illustrates the operation of the circuitry of FIG. 6. The timing diagram 120 shows the digital data signal 104, the digital counter signal 106, the emission clock signal (EM CLOCK), and the resulting light emission from the display pixel. In the example of FIG. 7, the gray level for driving the selected display pixel is gray level 4, and this is reflected in the digital data signal 104. The emission signal drives the display pixel “on” for a period of time defined as gray level 4 based on the emission clock signal (EM CLOCK). Namely, as the emission clock signal (EM CLOCK) rises and falls, the digital counter signal 106 gradually increases. The comparator 108 outputs the “hit” signal when the digital counter signal 106 reaches the value of the data signal 104. This causes the selected display pixel no longer to emit light.

The pulse spacing of the emission clock signal (EM CLOCK) may be based on the way the human eye perceives light. At lower gray levels, the absolute difference between the amounts of light between two consecutive gray levels is small. To notice differences between higher gray levels, however, the amounts of light emitted between two higher gray levels may be comparatively much greater. The emission clock signal (EM CLOCK) therefore may use relatively shorter time intervals between clock edges at first and may lengthen to account for increasingly higher light emission at higher gray levels.

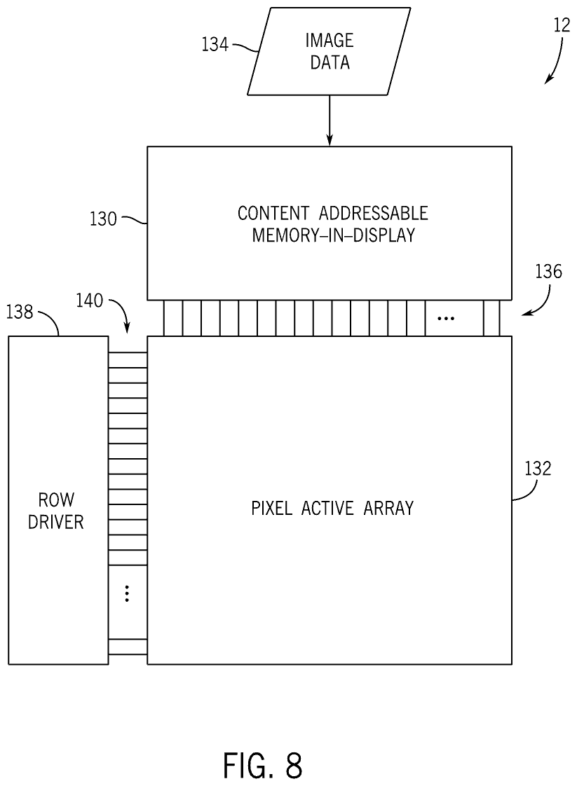

As shown in FIG. 8, the electronic display 12 may use a content-addressable memory-in-display (CAMiD) 130 to enable power- and area-efficient PWM to control display pixels of a pixel active array 132. The CAMiD 130 is a memory located outside of the pixel active array 132, and it contains image data 134 representing the binary value of the gray level corresponding to each display pixel in the pixel active array 132. The CAMiD 130 may control the display pixels of the pixel active array 132 using column lines 136. A row driver 138 may issue row write enable signals on row lines 140 to enable rows of display pixels of the pixel active array 132 to receive signals from the column lines 136. Note that there may be more column lines 136 than there are columns of display pixels of the pixel active array 132. Multiple column lines 136 per column of display pixels can be used in parallel, with each assigned a separate group of rows of display pixels of the pixel active array 132. For example, there may be two column lines 136 per column of display pixels of the pixel active array 132 (e.g., each column line 136 supplying control signals to half of the display pixels of the column of display pixels), three column lines 136 per column of display pixels of the pixel active array 132 (e.g., each column line 136 supplying control signals to one third of the display pixels of the column of display pixels), four column lines 136 per column of display pixels of the pixel active array 132 (e.g., each column line 136 supplying control signals to one quarter of the display pixels of the column of display pixels), five column lines 136 per column of display pixels of the pixel active array 132 (e.g., each column line 136 supplying control signals to one-fifth of the display pixels of the column of display pixels), six column lines 136 per column of display pixels of the pixel active array 132 (e.g., each column line 136 supplying control signals to one-sixth of the display pixels of the column of display pixels), or the like.

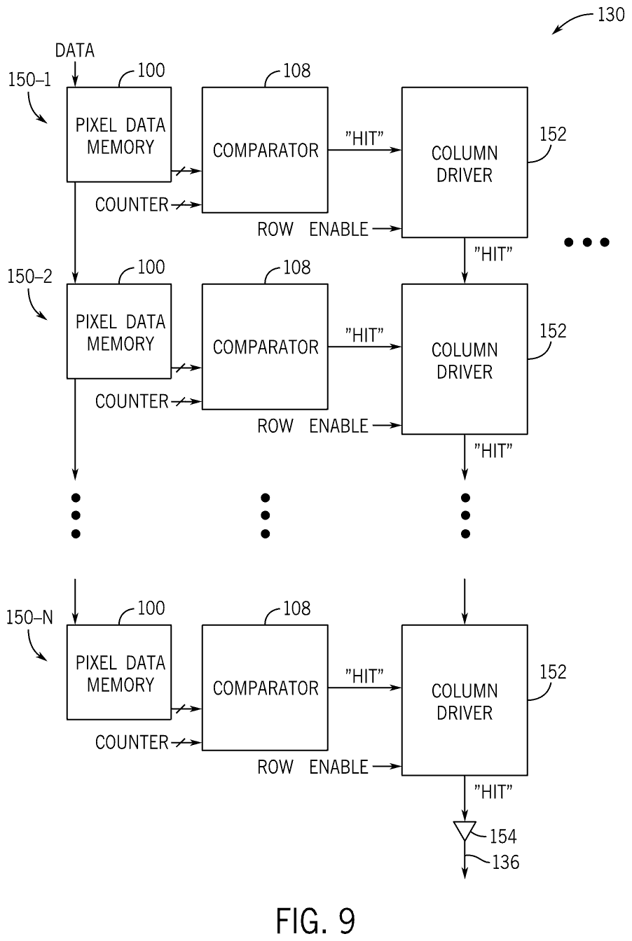

FIG. 9 provides one example of the CAMiD 130 architecture. The CAMiD 130 may include one core cell 150 (e.g., control cell, pixel circuit) for every pixel of the pixel active array 132. Each core cell 150 may include pixel data memory 100, a comparator 108, and a column driver 152. Here, one column of core cells 150-1, 150-2, . . . , 150-N are shown. There may be any suitable number of rows N and any suitable number of columns of core cells 150 based on the arrangement of display pixels of the pixel active array 132. Each pixel data memory 100 may be programmed by receiving image data passed along a data line shared by the other pixel data memory 100 in the column. The pixel data memory 100 and comparator 108 operate generally as discussed above with reference to FIG. 6. When the gray level stored in the pixel data memory 100 matches the current gray level value of the counter signal, a “hit” signal is obtained that indicates that the corresponding display pixel is to turn off. The column drivers 152 of each row of core cells 150 may be activated one row at a time based on a Row Enable signal. Based on the Row Enable signal, a column driver 152 may propagate a “hit” signal to a driver 154 (e.g., an inverter or a driver, depending on the signaling convention to be used by the column drivers 152) output on a column line 136 to cause the corresponding pixel in the pixel active array 132 to turn off.

In this way, the CAMiD 130 may operate pixel-row-by-pixel-row to reading pixel data corresponding to pixel data from the pixel data memory 100 for each display pixel of that row. The comparator 108 may compare the pixel data to a counter value (COUNTER) corresponding to the current gray level. When the counter value (COUNTER) does not correspond to the pixel data, the comparator 100 outputs a control signal in a first state (e.g., logical low, not “HIT”) to the column driver 152. When the counter value (COUNTER) does correspond to the pixel data, the comparator 100 outputs the control signal in a second state (e.g., logical high, “HIT”) to the column driver 152. The column driver 152 propagates the control signal to the pixel active area, and the display pixel may switch off in response to the control signal being in the second state. The CAMiD may do this for each gray level of each subframe of each frame displayed on the electronic display. Every frame may include a number of subframes taking place over time.

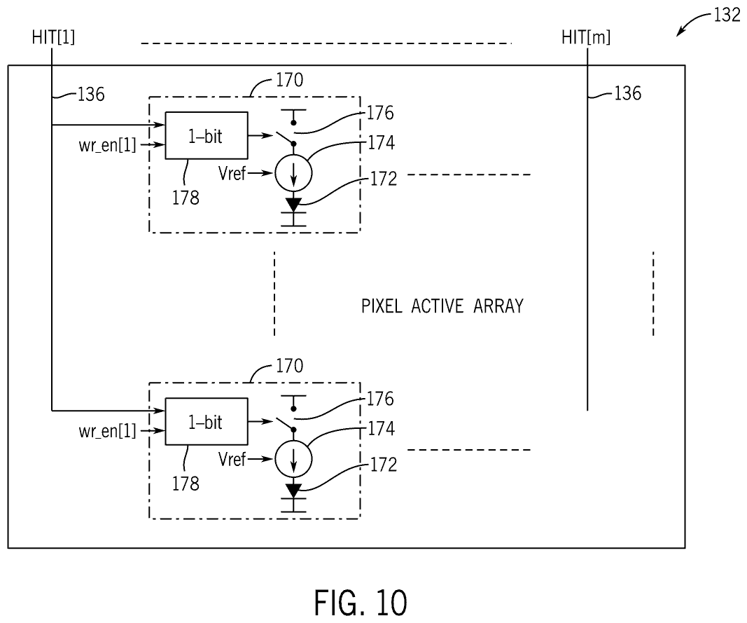

For example, as shown in FIG. 10, each column line 136 may connect to multiple display pixels 170 of the pixel active array 132. There may be any suitable number n of rows and number m of columns of display pixels 170 in the pixel active array 132. Each display pixel 170 may include a micro-LED 172 driven at a defined current by a current source 174. The current source 174 may be driven based on a reference voltage Vref, which may be selected to cause the current source 174 to efficiently drive the micro-LED 172. A switch 176 controls whether the current source 174 is on or off. A 1-bit memory 178 (e.g., a latch) may control the switch 176. The 1-bit memory 178 of each display pixel 170 may be enabled to receive a signal on its column line 136 when a corresponding Write Enable signal wr_en[1] . . . wr_en[n] is provided. Thus, programming the 1-bit memory 178 causes the display pixel 170 to turn on or off.

The Row Enable signals of the CAMiD 130 may correspond with the Write Enable signals in the pixel active array 132. For each new gray level represented by an increment of the counter signal, each core cell 150 in the CAMiD 130 may be tested row by row. For each row, only if there is a match between the gray level of the counter signal and the gray level stored in the pixel data memory 100 will any display pixel 170 be reprogrammed, turning the display pixel 170 off. This may consume negligible power.

Consider an example where there are 20 rows of core cells 150 corresponding to 20 rows of display pixels 170 and each core cell 150 holds an 8-bit gray level (for gray levels 0 to 255). To display one subframe, the counter signal may increase from 0 to 1 to 2 . . . to 255 based on an emission clock signal. Each time the counter signal increments, each core cell 150 may compare the present counter signal value with the gray level value that it holds. For each counter signal value, the Row Enable signals may selectively enable row 1, then row 2, then row 3, . . . , until all rows of core cells 150 have done a comparison and indicated whether there is a “hit. ” At the same time, the Write Enable signals may be applied to the respective row of display pixels 170, one row at a time. If there is a “hit” on a core cell 150 at a particular row in the CAMiD 130, the “hit” signal will travel to the corresponding display pixel 170 in the corresponding row in the pixel active array 132 to cause that display pixel 170 to turn off. In this way, each display pixel 170 may be controlled to emit light according to the gray level stored in the corresponding core cell 150 in the CAMiD 130.

Note that, while this disclosure describes a content-addressable memory-in-display architecture, the circuits of this disclosure may also be used in a memory-in-pixel arrangement if the pixel active array has enough space to fit the circuitry with each display pixel. Moreover, where logic circuitry is described below as NMOS, PMOS, or CMOS, these circuits are provided by way of example. Equivalent or substantially similar logic circuitry may be formed based on other arrangements (e.g., NMOS transistors may be replaced by PMOS transistors based on inverted signals, or vice versa).

### CAMiD Column Drivers

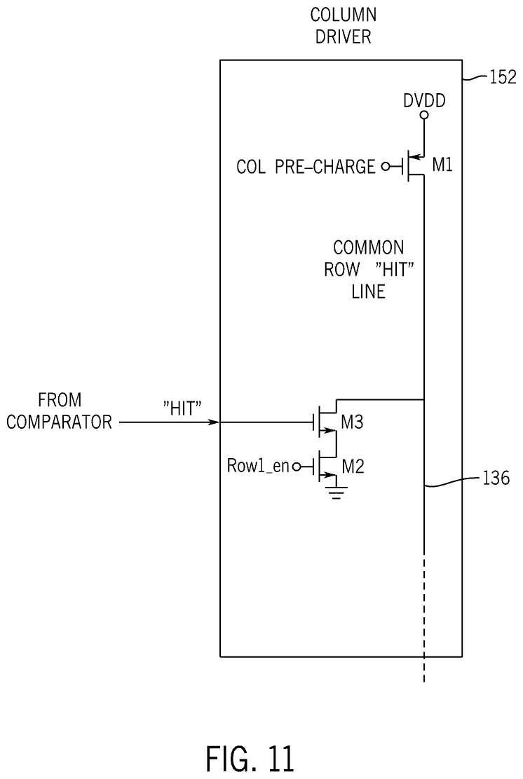

The column drivers 152 of the CAMiD 130 may take any suitable form to efficiently propagate a control signal (e.g., “hit” signal) down to a column line 136. For example, as shown in FIG. 11, a column driver 152 may be a dynamic column driver that indicates a “hit” by driving the column line 136 low. A PMOS transistor M1 may receive a column pre-charge (Col Precharge) signal, an NMOS transistor M2 may receive a Row Enable (row_en) signal, and an NMOS transistor M3 receives a “hit” signal from the comparator. In the example of FIG. 11, the column driver 152 uses a column line 136 that is a passive line that indicates no match whenever it is high. The column line 136 is driven high (to a high supply voltage DVDD) by the Col Precharge signal when no row is active, including in the time between one row getting active and the next. Each row is activated by the row_en signal. If both row_en is high and the “hit” signal from the comparator is high, the column driver 152 of FIG. 11 will pull down the column line 136 signal, communicating to the corresponding display pixel 170 in the pixel active array 132 in that row and column that it should turn off. This implementation has low area and propagation across the column is fast.

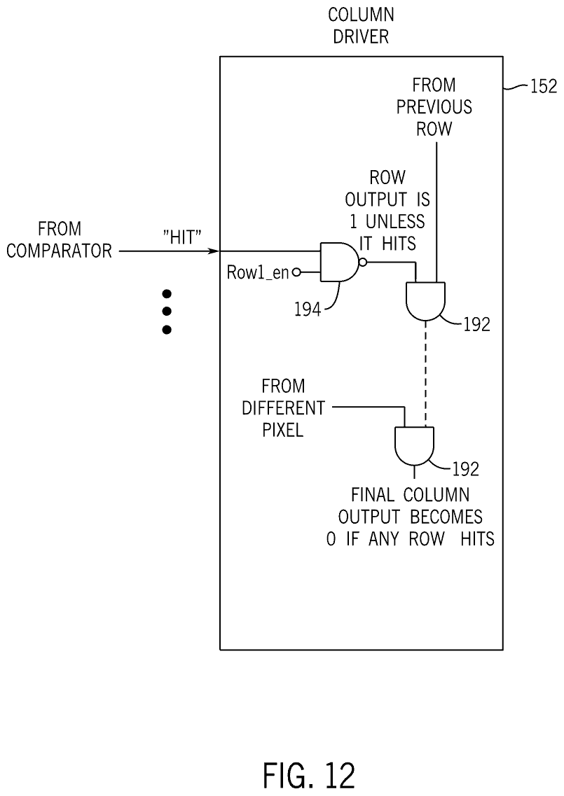

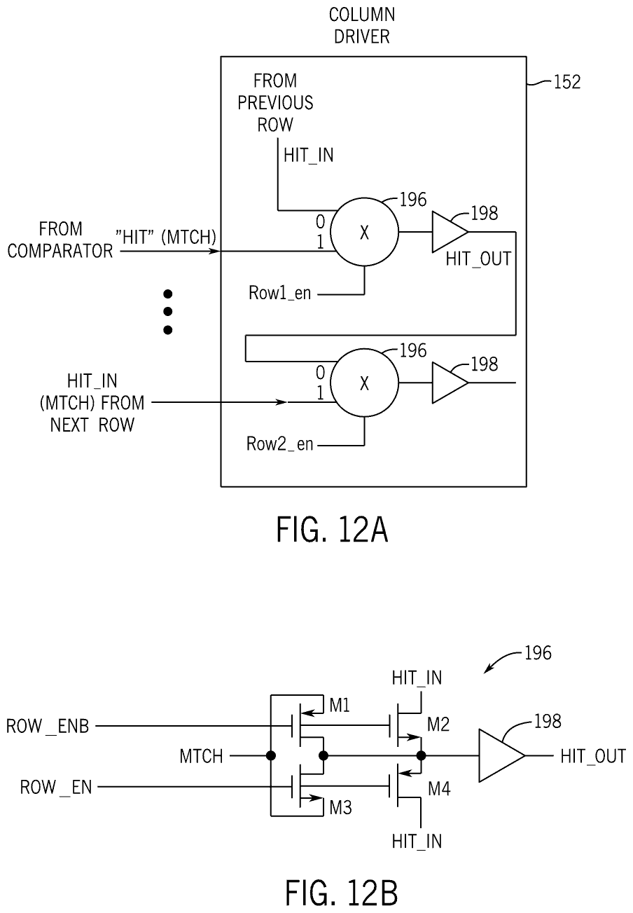

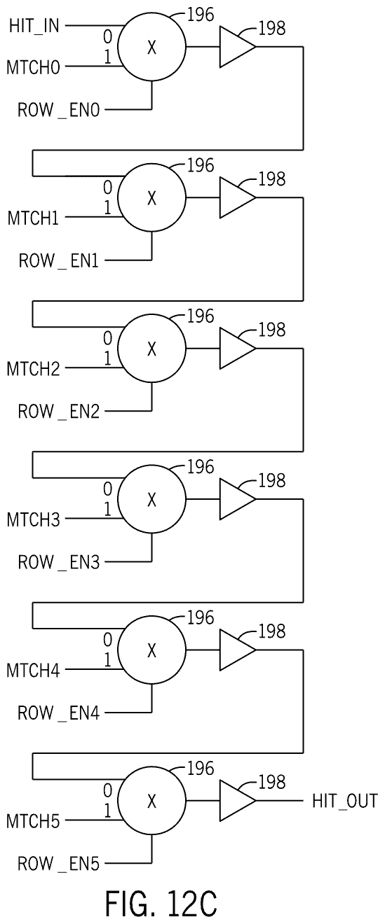

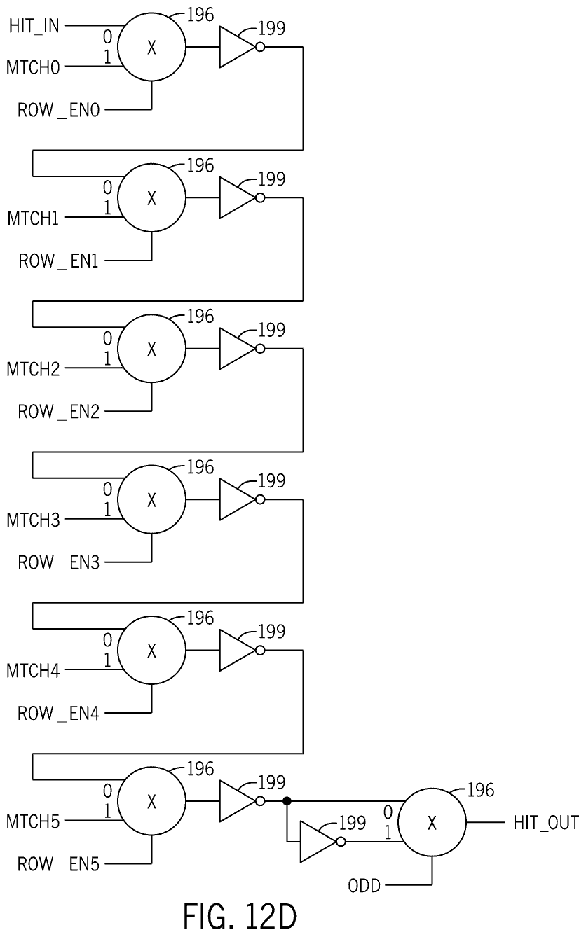

FIG. 12 illustrates an example of a static column driver 152. The signal from each previous row is connected to the next row with an AND gate 192. A NAND gate 194 receives a Row Enable (row_en) signal and a “hit” signal from the comparator. In effect, each column driver of each core cell 150 contains an AND gate 192 that adds their output to the previous one, so that if any of them receive a high “hit” signal, the column output becomes 0. Each row is activated by the row_en signal. If both row_en is high and the “hit” signal from the comparator is high, the column driver 152 will pull down the column line 136 signal communicating to the corresponding display pixel 170 in the pixel active array 132 in that row and column that it should turn off. This implementation may be insensitive to couplings, noise, leakage, and may have faster edge rates.

FIG. 12A illustrates an example of a serial complementary metal-oxide-semiconductor multiplexer (CMOS-mux) column driver 152. The signal from each previous row is connected to the next row through an analog serial CMOS-mux 196 followed by a digital buffer 198. Each CAMiD cell portion of the CMOS-mux column driver 152 either passes the previous value (HIT_IN) as its output (HIT_OUT), or injects is own value (MTCH) as its output (HIT_OUT), depending on a logical state of a row enable signal (e.g., Row1_en, Row2_en) that operates as a MUX selection signal. The output (HIT_OUT) of one CAMiD cell portion of the CMOS-mux column driver 152 becomes one of the inputs (HIT_IN) to the next CAMiD cell portion of the CMOS-mux column driver 152.

FIG. 12B provides one example of the analog serial CMOS-mux 196, made up of four CMOS transistors M1, M2, M3, and M4, where transistors M1 and M2 are P-channel metal-oxide semiconductor (PMOS) transistors and transistors M3 and M4 are N-channel metal-oxide semiconductor (NMOS) transistors. The gates of the transistors M2 and M3 are coupled to a row enable signal (ROW_EN) that is logically high when the CAMiD cell portion of the CMOS-mux column driver 152 corresponding to its row of pixels is enabled and logically low otherwise. The gates of the transistors M1 and M4 are coupled to an inverse of the row enable signal (ROW_ENB) that is logically low when the CAMiD cell portion of the CMOS-mux column driver 152 corresponding to its row of pixels is enabled and logically high otherwise. The value from the comparator for that row (MTCH) is coupled to the source terminals of the M1 and M3 transistors. The value from the previous row (HIT_IN) is coupled to the drain terminals of the M2 and M4 transistors. Thus, when the ROW_EN signal is high (and the ROW_ENB is low), the MTCH signal is passed along to the digital buffer 198. When the ROW_EN signal is low (and the ROW_ENB is high), the HIT_IN signal received from the previous row is passed along to the digital buffer 198.

Many CAMiD cells, each including their own analog CMOS-Mux 196 and buffer 198, are connected in serial to form one CMOS-mux column driver 152. One simplified example with six rows is shown in FIG. 12C. In practice, there may be thousands of rows for each CMOS-mux column driver 152. The analog CMOS-Mux 196 of each CAMiD receives a particular row enable signal (e.g., ROW_EN, ROW_ENB). The output of the CAMiD cell for the final row produces a HIT_OUT signal that goes to the active area of the display panel.

To further reduce the number of transistors in the CMOS-mux column driver 152, the digital buffers 198 may be replaced by inverters 199, as shown in FIG. 12D. The output of the CAMiD cell for the final row may be provided to a final CMOS-Mux 196. The final CMOS-Mux 196 may select between the output of the CAMiD cell for the final row and its inverse produced by another inverter 199. The final CMOS-Mux 196 may select between these based on whether the current row is even or odd (e.g., an ODD signal, operating as a selection signal, may be logically high when the current row is odd and logically low when the current row is even). The output of the final CMOS-Mux 196 is the HIT_OUT signal that goes to the active area of the display panel.

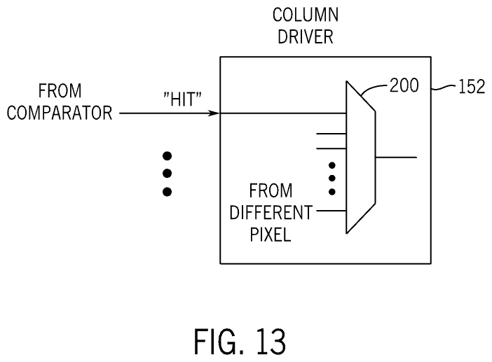

FIG. 13 is an example of a digital multiplexer-based column driver 152. Each column line 136 may be driven by a digital multiplexer 200 with as many inputs as rows associated to that column line 136. Each row is activated by the multiplexer selection. In this case, the column line output is high if the “hit” signal from the comparator output is high. This implementation is insensitive to couplings, noise, leakage, and it has fast propagation and edge rates, but may take up more die area.

### CAMiD Comparators

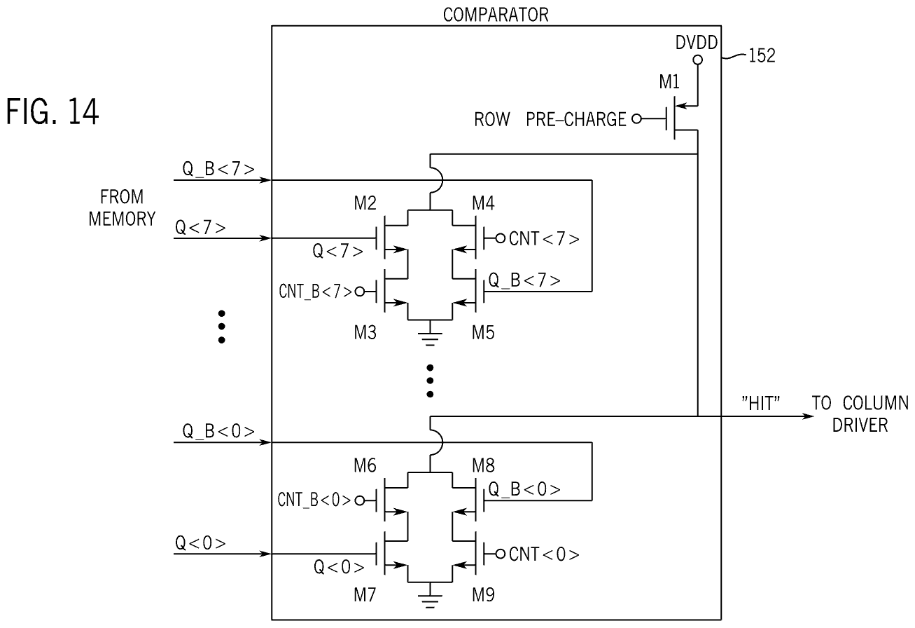

The comparators 108 of the CAMiD 130 may also take any suitable form. For example, FIG. 14 illustrates a dynamic comparator 108. The dynamic comparator 108 of FIG. 14 includes a PMOS transistor M1 and NMOS transistors grouped in parallel to form pull-down OR gates for each bit of memory and its inverse compared with each counter value and its inverse. For example, NMOS transistors M2, M3, M4, and M5 are arranged so that transistors M2 and M3 compare a most significant bit (MSB) from the pixel data memory (Q<7>) with the inverse of a corresponding MSB from the counter (CNT_B<7>). Correspondingly, transistors M4 and M5 likewise compare a most significant bit (MSB) from the counter (CNT<7>) with the inverse of a corresponding MSB from the pixel data memory (Q_B<7>). This continues for all bits of the memory and counter (e.g., as also illustrated for the least significant bit (LSB) with NMOS transistors M6, M7, M8, and M9). To operate, right before activating the row with row_en, the row_precharge signal on the transistor M1 pulls up the output of the comparator 108 (connecting to a high supply voltage DVDD). If there is no match, one of the branches in the comparator 108 will pull the output low. If there is a match, all the branches in the comparator 108 will be high impedance and the comparator output will stay high. This solution has low area and the output is driven strongly.

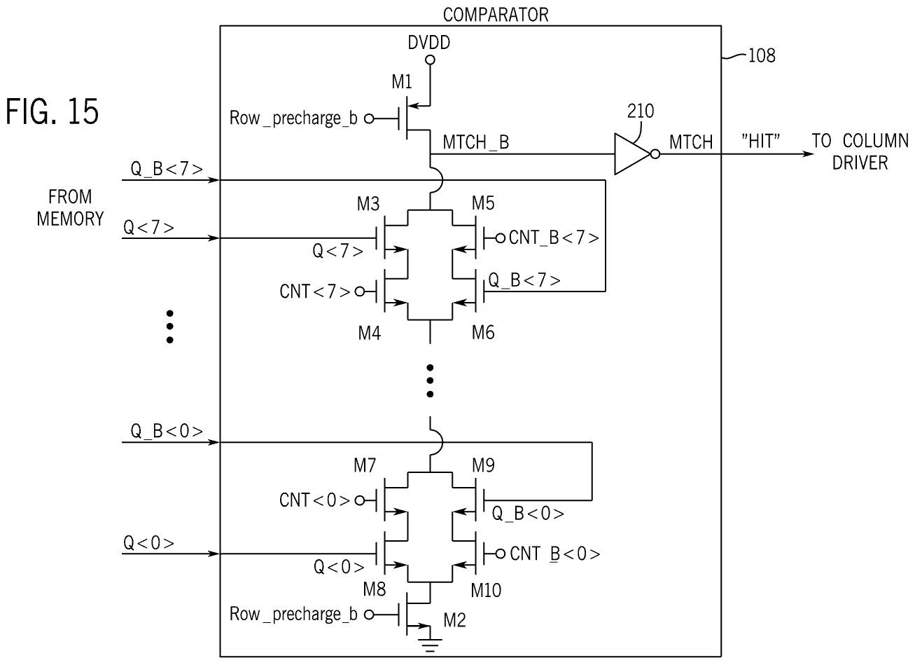

FIG. 15 is an example of the comparator 108 as a dynamic AND-based comparator. The dynamic AND-based comparator 108 of FIG. 15 includes a PMOS transistor M1 that receives an inverse row precharge (row_precharge_b) signal (to cause it to connect to a high supply voltage DVDD all times except when the row is enabled) and an NMOS transistor M2 that receives also receives the inverse row precharge (row_precharge_b) signal (to cause it to be high impedance at all times except when the row is enabled and it connects to ground). Other NMOS transistors grouped in series to form one pull-down AND gate for each bit of memory and its inverse compared with each counter value and its inverse. For example, NMOS transistors M3, M4, M5, and M6 are arranged so that transistors M3 and M4 compare a most significant bit (MSB) from the pixel data memory (Q<7>) with the corresponding MSB from the counter (CNT<7>). Correspondingly, transistors M5 and M6 likewise compare the inverse of the most significant bit (MSB) from the counter (CNT_B<7>) with the inverse of a corresponding MSB from the pixel data memory (Q_B<7>). This continues for all bits of the memory and counter (e.g., as also illustrated for the least significant bit (LSB) with NMOS transistors M7, M8, M9, and M10). Here, there is a single branch with all the comparator transistors in series. Row_precharge keeps an inverse “hit” signal MTCH_B high until it is time to compare, and if there is a match then MTCH_B goes low, staying high otherwise. An inverter 210 inverts the MTCH_B signal to the column driver. This solution is only slightly larger than the OR-based (by 3 transistors) and, when there is a match, the drive is much weaker because of the series transistors; however, it prevents crowbar currents and does not involve careful timing between the row precharge signal and the row enable signal.

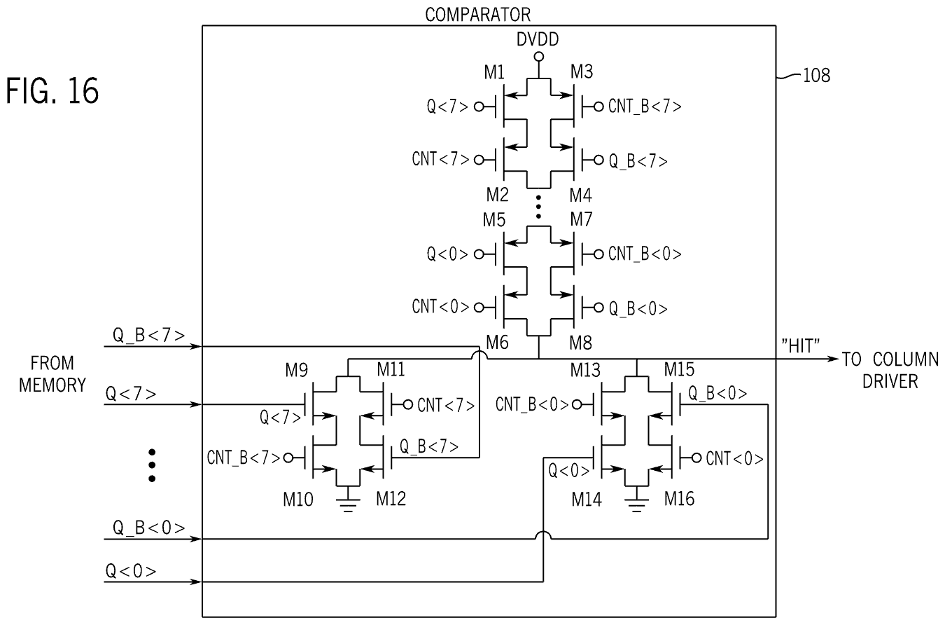

FIG. 16 is an example of the comparator 108 as a static complementary comparator 108. The static comparator 108 of FIG. 16 includes groups of PMOS transistors arranged in series as a pull-up AND gate and groups of NMOS transistors arranged as a parallel OR of pull-down AND gates. For example, PMOS transistors M1, M2, M3, M4, M5, M6, M7, and M8 correspond to AND comparisons between bits of the counter signal and the corresponding data bits and AND comparisons between bits of the inverse of the counter signal and the inverse of the corresponding data bits. NMOS transistors M9, M10, M11, and M12 correspond to AND comparisons between bits of the inverse of the counter signal and the corresponding data bits. These are in a parallel OR with similar AND gates for other bits such as M13, M14, M15, and M16. In this way, the comparator 108 goes high when there is a match and pulls down all other times.

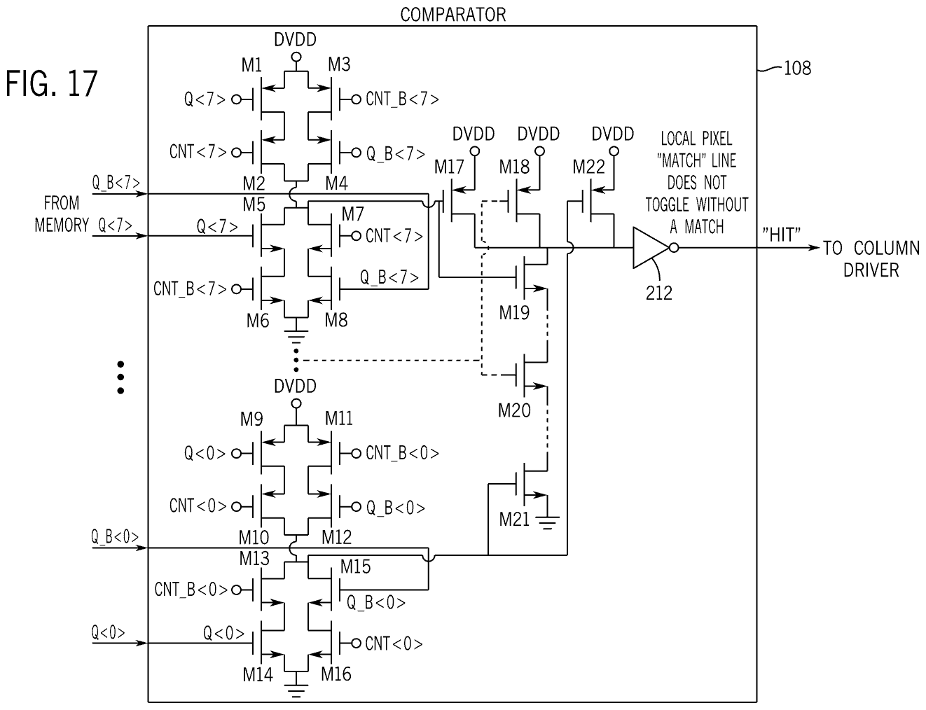

FIG. 17 is another example of the comparator 108 in the form of a static comparator 108. Here, there are complementary groups of PMOS and NMOS transistors that perform a similar comparison to those of FIG. 16, but there are also corresponding pull-up and pull-down transistors that act on the resulting comparisons. For example, PMOS transistors M1, M2, M3, M4, M9, M10, M11, and M12 correspond to AND comparisons between bits of the counter signal and the corresponding data bits and AND comparisons between bits of the inverse of the counter signal and the inverse of the corresponding data bits. NMOS transistors M5, M6, M7, M8, M13, M14, M15, and M16 correspond to AND comparisons between bits of the counter signal and the inverse of the corresponding data bits and AND comparisons between bits of the inverse of the counter signal and the corresponding data bits. The results of each complementary group (e.g., M1, M2, M3, M4, M5, M6, M7, and M8) are provided to complementary pull-up transistors arranged in parallel (e.g., PMOS transistors M17, M18, and M22) and pull-down transistors arranged in series (e.g., NMOS transistors M19, M20, and M21). An inverter 212 may not toggle until there is a match, saving dynamic power.

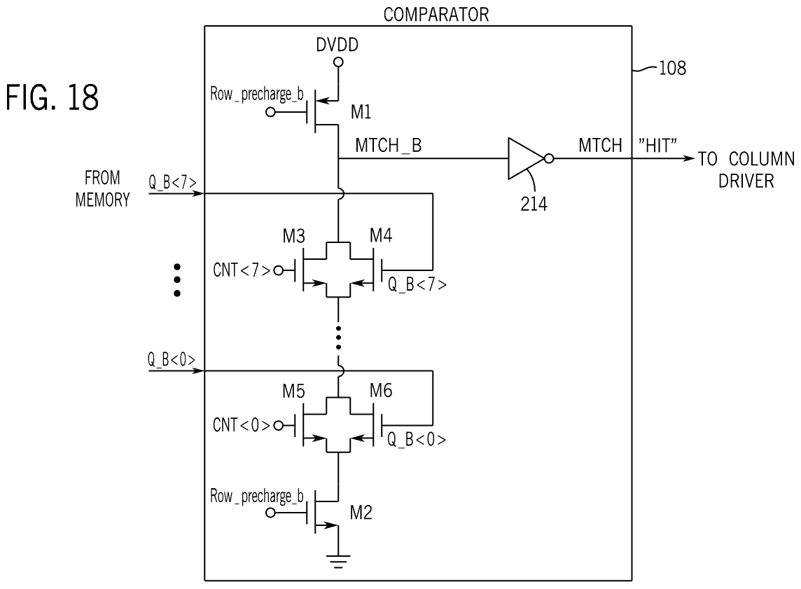

FIG. 18 is an example of the comparator 108 in the form of a dynamic comparator 108 that generates a match at the earliest matching counter value, but also generates false matches for higher counter values. It does not look for a perfect match, but the first match happens when the provided gray code from the counter is equal or larger than the stored value from the memory. Hence, the point to turn off the pixel is correct. In this example, the dynamic comparator 108 of FIG. 15 includes a PMOS transistor M1 that receives an inverse row precharge (row_precharge_b) signal (to cause it to connect to a high supply voltage DVDD all times except when the row is enabled) and an NMOS transistor M2 that receives the inverse row precharge (row_precharge_b) signal (to cause it to be high impedance at all times except when the row is enabled and it connects to ground). Other NMOS transistors grouped in series to form one pull-down AND gate of OR combinations of each inverse bit of memory and its corresponding counter value bit. For example, NMOS transistors M3, M4, M5, and M6 are arranged so that transistors M3 and M4 compare the inverse of the most significant bit (MSB) from the pixel data memory (Q_B<7>) with the corresponding MSB from the counter (CNT<7>). Correspondingly, transistors M5 and M6 likewise compare the inverse of the least significant bit (LSB) from the pixel data memory (Q_B<0>) with the corresponding LSB from the counter (CNT<0>). This continues for all bits of the memory and counter. Here, there is a single branch with all the comparator transistors in series. Row_precharge_b keeps an inverse “hit” signal MTCH_B high until it is time to compare, and if there is a match then MTCH_B goes low, staying high otherwise. An inverter 214 inverts the MTCH_B signal to the column driver.

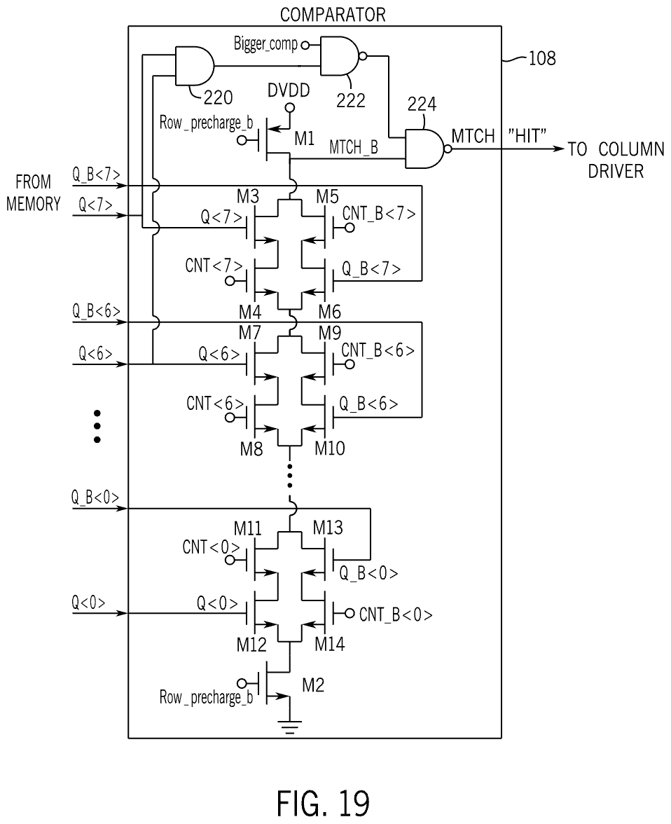

FIG. 19 provides an example of a comparator 108 that includes a “bigger than” function. The example of FIG. 19 is based on the circuitry of FIG. 15, but the “bigger than” logic added in FIG. 19 may be applied to any other comparator structure. The example of FIG. 19 includes a PMOS transistor M1 that receives an inverse row precharge (row_precharge_b) signal (to cause it to connect to a high supply voltage DVDD all times except when the row is enabled) and an NMOS transistor M2 that receives the inverse row precharge (row_precharge_b) signal (to cause it to be high impedance at all times except when the row is enabled when it is connected to ground). Other NMOS transistors grouped in series to form one pull-down AND gate for each bit of memory and its inverse compared with each counter value and its inverse. For example, NMOS transistors M3, M4, M5, and M6 are arranged so that transistors M3 and M4 compare a most significant bit (MSB) from the pixel data memory (Q<7>) with the corresponding MSB from the counter (CNT<7>). Correspondingly, transistors M5 and M6 likewise compare the inverse of the most significant bit (MSB) from the counter (CNT_B<7>) with the inverse of a corresponding MSB from the pixel data memory (Q_B<7>). This continues for all bits of the memory and counter (e.g., as also illustrated for the least significant bit (LSB) with NMOS transistors M7, M8, M9, M10, M11, M12, M13, and M14). Additional logic including an AND gate 220 is added to check if the two most significant bits of the pixel data are high (e.g., Q<7> and Q<6>).

The output of the AND gate 220 may enter a NAND gate 222 that also receives a “bigger than” enable signal bigger_comp. This is used to determine if the top two MSBs of the pixel data are 1 and, hence, that the pixel data has a “large” gray level value. The bigger_comp signal thus may be selectively applied to do generate a “hit” from a NAND gate 224 for larger gray levels. This can be readily changed to either add more bits to the comparison, or remove one bit and focus on the MSB only. Note that, when bigger_comp is high, row_precharge_b is low and row_en is high. This functionality is useful to separate the gray levels to be emitted in different subframes depending on the gray level value.

### CAMiD Subframe Dithering

The electronic display 12 may be so fast that, for a total period of time that single frame of image data is displayed on the electronic display 12, the electronic display 12 may display numerous subframes. Since multiple subframes may be displayed over the course of displaying one image frame, subframe-based dithering may be used to achieve a greater brightness resolution resulting in more possible colors. Dithering is a process where, for a particular constant image to be shown to the viewer, different subframes cause the gray level value of a pixel to alternate between different gray level values. The human eye averages these values and sees a middle gray level value. For example, to achieve an equivalent gray level of 2.5 at a particular display pixel, the display pixel may be pulsed at a gray level of 2 for a first subframe and a gray level of 3 for a second subframe.

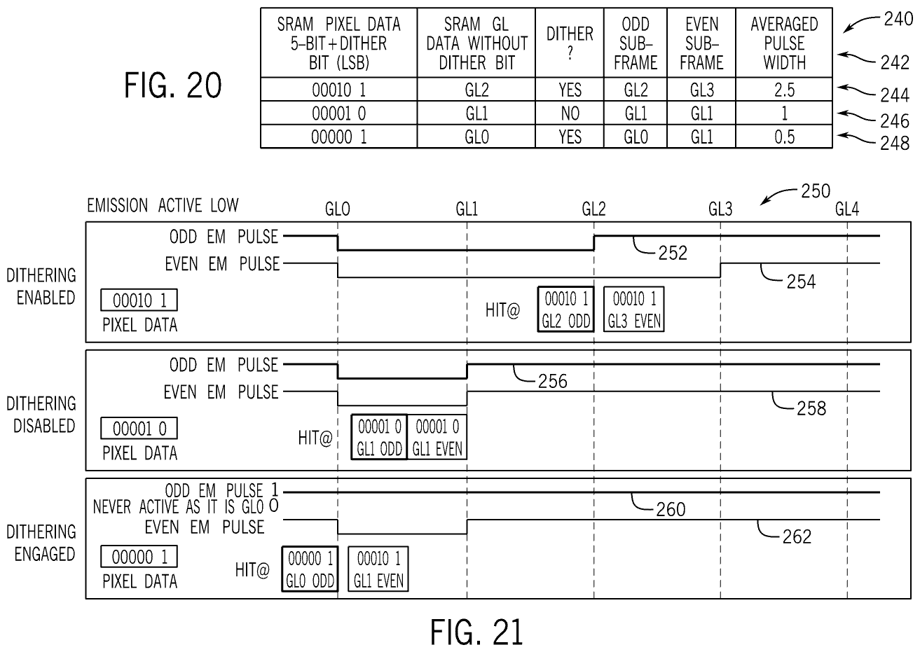

FIGS. 20 and 21 provide a few examples. For ease of explanation, FIGS. 20 and 21 use 6-bit data where the 5 most significant bits represent the gray level (e.g., from a lowest gray level 0 to a highest gray level 31) and the lowest significant bit represents a dither bit. Thus, this is considered 1-bit dithering and intermediate gray levels may be achieved using two alternating subframes. In effect, if the dither bit is 0, no dithering occurs between subframes. If the dither bit is 1, the electronic display may switch between the 5-bit value and the 5-bit value plus 1 in the odd and even subframes. Moreover, while these examples relate to 1-bit dithering using two alternating subframes, other dithering bit depths may be used. For example, 2-bit dithering may be performed using four alternating subframes, 3-bit dithering may be performed using eight alternating subframes, and so on.

FIG. 20 provides a table 240 showing one implementation of subframe dithering. Headers 242 of the table 240 list the pixel data stored in the pixel data memory, the gray level of the data without taking into account the dither bit, whether there is a dither bit, a gray level to be displayed in a first (e.g., odd) subframe, a gray level to be displayed in a second (e.g., even) subframe, and the resulting average PWM gray level when the light is integrated by the human eye. For a first set of pixel data 244, the data is “000101”, meaning that the gray level represented by the 5 MSBs is gray level 2 (GL2) and there is a dither bit. This pixel data may be displayed in a first subframe as gray level 2 (GL2) and in a second subframe as gray level (GL3), to achieve an average gray level of 2.5 when seen by the human eye. For a second set of pixel data 246, the data is “000010”, meaning that the gray level represented by the 5 MSBs is gray level 1 (GL1) and there is not a dither bit. This pixel data may be displayed in a first subframe as gray level 1 (GL1) and in a second subframe as gray level (GL1), to achieve an average gray level of 1 when seen by the human eye. For a third set of pixel data 248, the data is “000001”, meaning that the gray level represented by the 5 MSBs is gray level 0 (GL0) and there is a dither bit. This pixel data may be displayed in a first subframe as gray level 0 (GL0) and in a second subframe as gray level (GL1), to achieve an average gray level of 0.5 when seen by the human eye.

FIG. 21 is a timing diagram 250 illustrating the subframe dithering operation. Pulses 252 and 254 are odd and even pulses corresponding to the first set of pixel data 244. To generate the odd subframe pulse 252, the circuitry of the electronic display may interpret the first set of pixel data 244 to generate a “hit” signal to turn off the display pixel at gray level 2 (GL2). To generate the even subframe pulse 254, the circuitry of the electronic display may interpret the first set of pixel data 244 to generate a “hit” signal to turn off the display pixel at gray level 3 (GL3). This produces a resulting average pulse corresponding to about gray level 2.5. Pulses 256 and 258 are odd and even pulses corresponding to the second set of pixel data 246. To generate the odd subframe pulse 256, the circuitry of the electronic display may interpret the second set of pixel data 246 to generate a “hit” signal to turn off the display pixel at gray level 1 (GL1). To generate the even subframe pulse 258, the circuitry of the electronic display may interpret the second set of pixel data 246 to generate a “hit” signal to turn off the display pixel at gray level 1 (GL1). This produces a resulting average pulse corresponding to gray level 1. Pulses 260 and 262 are odd and even pulses corresponding to the third set of pixel data 248. To generate the odd subframe pulse 260, the circuitry of the electronic display may interpret the third set of pixel data 248 to generate a “hit” signal to keep the display pixel off at gray level 0 (GL0). To generate the even subframe pulse 262, the circuitry of the electronic display may interpret the third set of pixel data 248 to generate a “hit” signal to turn off the display pixel at gray level 1 (GL1). This produces a resulting average pulse corresponding to about gray level 0.5.

There are numerous ways that the electronic display may interpret the pixel data to perform subframe dithering. Implementing dithering between subframes with a CAMiD memory involves special logic because the pixel data for the display may remain the same (e.g., not updated) between image subframes. Thus, the CAMiD memory may interpret that data in a way that causes the gray level in each subframe to change only for the desired pixels. Two primary approaches include column-level dithering, which trades read speed for area, and CAMiD pixel-level dithering, which trades area for read speed. Note that, while these techniques are described separately, they may also be used in conjunction with one another.

### Column-Level CAMiD Subframe Dithering

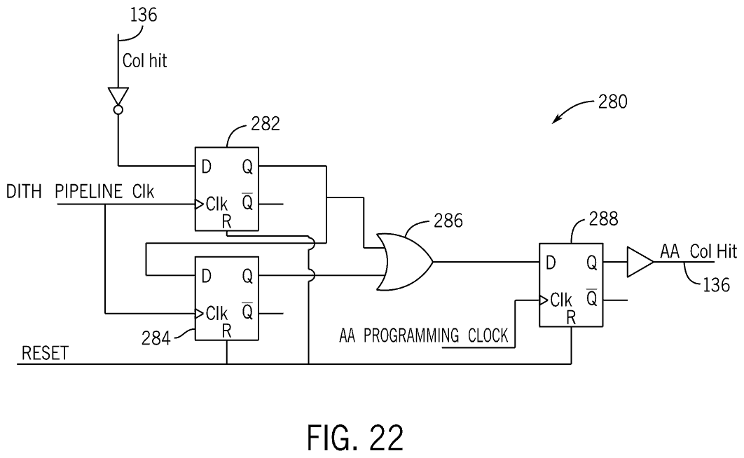

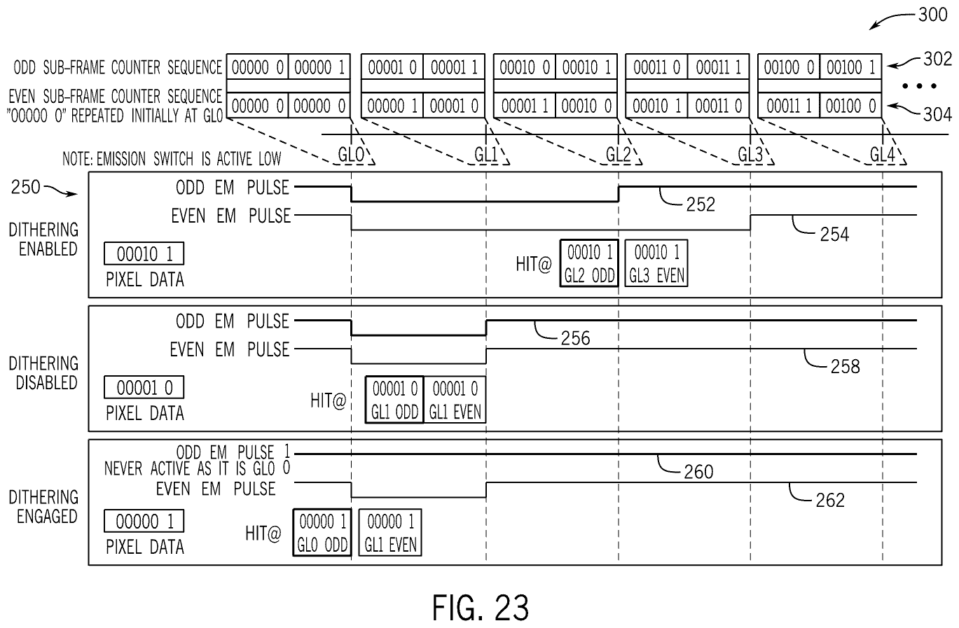

In column-level dithering, the core cells of the CAMiD memory containing the pixel data and comparator may take any form. At each gray level cycle (e.g., where all of the rows are compared and “hit” signals generated row-by-row if there is a match) in each subframe, the comparator of a core cell may compare multiple counter values of gray level instead of one. For 1-bit dithering, two reads occur per gray level cycle. For 2-bit dithering, four reads occur per gray level cycle, and so forth. FIGS. 22 and 23 will provide an example of 1-bit dithering for ease of explanation, it should be appreciated that any suitable column-level bit depth may be used.

FIG. 22 illustrates a column-level dithering circuit 280 that may be located along each column line 136. Flip-flops 282 and 284 may store the output of the multiple reads from the core cell row that is currently enabled and decide (e.g., using an OR gate 286) if that display pixel in the pixel active area should be turned off or not. Since there are two adjacent reads per row for each gray level cycle, the flip-flops 282 and 284 are clocked to store two reads for every active area row programming period. Thus, the flip-flops 282 and 284 may receive a dithering clock signal Dith Pipeline Clk that is double that of an active area row programming clock signal AA Programming clock. A flip-flop 288, clocked to the AA Programming clock, may store the result of the decision from the OR gate 286 and output the resulting “hit” signal as an AA Col Hit on the column line 136 into the pixel active array 130.

FIG. 23 overlays the timing diagram 250 with column-level dithering counter sequences 300 for odd subframes reads 302 and even subframe reads 304. For a description of the timing diagram 250, see the discussion of FIG. 21 above. In FIG. 23, the odd subframes reads 302 involve counter values that start at 00000 and increment by 1 twice for every gray level cycle. The even subframes reads 304 also involve counter values that start at 00000 and increment by 1 twice for every gray level cycle, but only after the first two reads are set to 00000. This has the effect that only even subframes extend the pulse in this implementation. In other words, in the odd subframe for each gray level, that gray level value (e.g., the 5 MSBs) is read and the same gray level value with dithering bit high. In the even subframe for each gray level value, that gray level value is read and the previous gray level value is read with the dithering bit high.

### Pixel-Level CAMiD Subframe Dithering

For pixel-level dithering, logic circuitry on the CAMiD core cell (not in the pixel active array) may determine whether to apply subframe dithering. Three different topologies are presented as examples, though these may be used in combination or extended in other examples. In a first example implementation, as many comparators as possible dithering values are added to CAMiD core cell, and different counter values are used for each comparator as in the column-level dithering, but doing multiple comparisons in parallel. In a second example implementation, two comparators are used per CAMiD core cell independently of the number of dither bits, one comparing with the current gray level value, and one with the previous one. Then only one of the comparators is selected depending on a carry-bit value that is calculated as the sum of the dithering bits and the subframe index. In a third example implementation, a single comparator is used, but a local latch is added to each CAMiD core cell and additional logic decides if the hit signal output should be based on the comparator output or the latch output. In these ways, the CAMiD architecture may be used to achieve efficient subframe dithering.

As with the column-level subframe dithering approach mentioned above, the pixel-level dithering approaches discussed below with the first implementation topology will relate to 1-bit dithering. However, this may be extended to dithering of other bit depths adding more comparators and modifying the logic. For example, 2-bit dithering may involve comparing four simultaneous counter values, 3-bit dithering may involve comparing eight simultaneous counter values, and so on. With respect to carry-bit dithering, a subframe index signal (e.g., indicating a subframe index) may allow multi-bit dithering using only two counters that are selectively compared based on a carry bit that results based on a sum of the dithering bits and the present multi-bit subframe index.

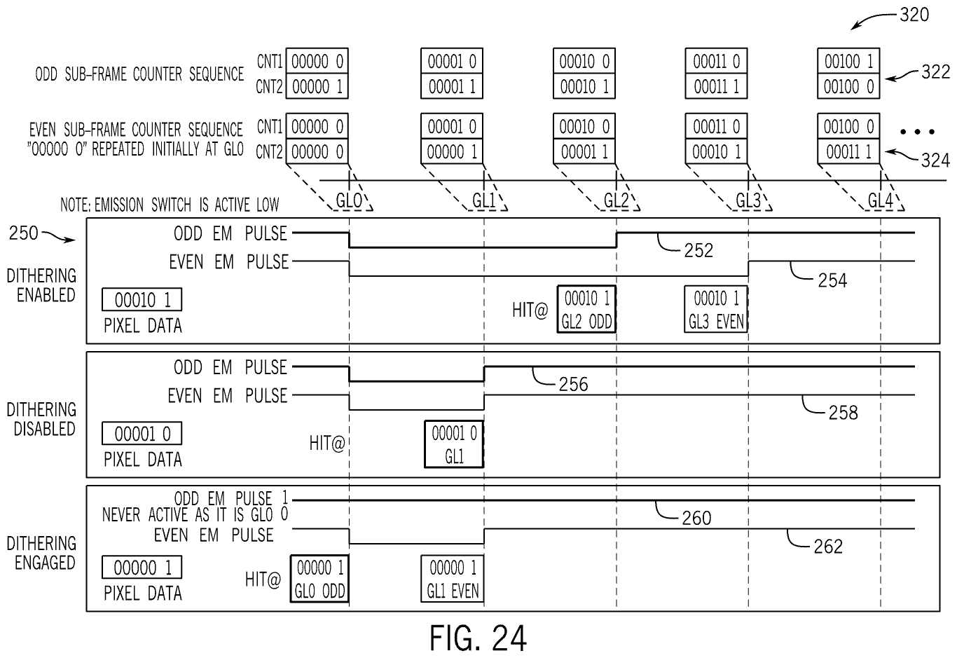

FIG. 24 illustrates one example of 1-bit pixel-level subframe dithering using multiple comparators per CAMiD core cell. FIG. 24 overlays the timing diagram 250 with pixel-level dithering counter sequences 320 for odd subframes 322 and even subframes 324. For a description of the timing diagram 250, see the discussion of FIG. 21 above. In FIG. 24, both the odd subframes 322 and the even subframes 324 involve providing two simultaneous counter values to comparators of the core cells. In the odd subframes 322, the two counter values start at 00000 and increment by 1 twice for every gray level cycle. The even subframes reads 304 also involve counter values that start at 00000 and increment by 1 twice for every gray level cycle, but only after the first two reads are set to 00000. This has the effect that only even subframes extend the pulse.

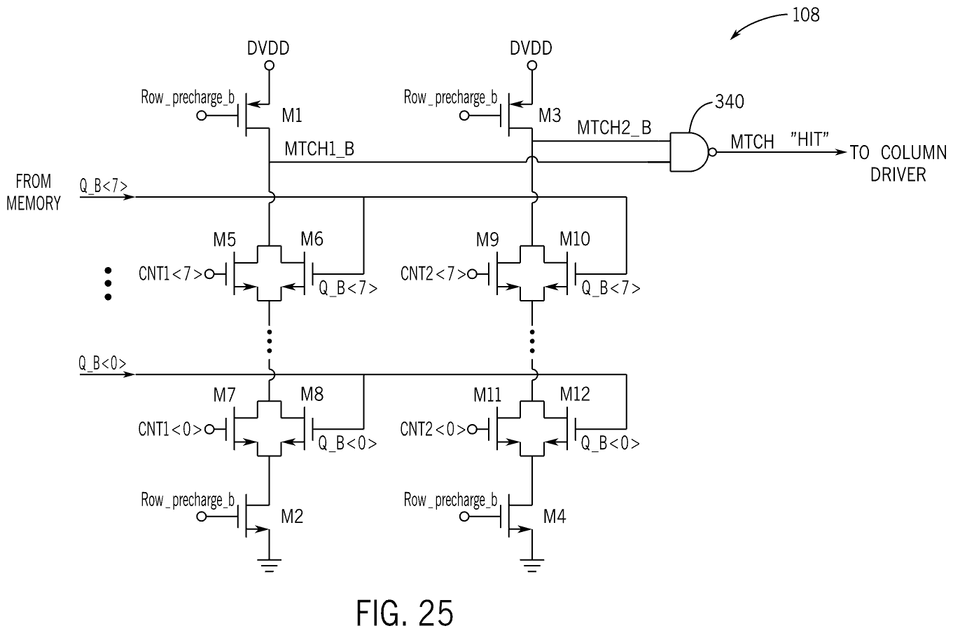

FIG. 25 illustrates circuitry that may be included in a comparator 108 to carry out the pixel-level dithering illustrated in FIG. 24. The comparator 108 of FIG. 25 compares two counter signals CNT1 and CNT2. Note that, while a dynamic comparator structure is shown in FIG. 25, any suitable structure to compare two counter signals may be used. Here, transistors M1, M2, M3, and M4 respectively pull up or pull down based on an inverse of a row precharge signal to produce respective inverse match signals MTCH1_B and MTCH2_B that feed into a NAND gate 340. The inverse match signal MTCH1_B is pulled down by transistor groups illustrated by M5, M6, . . . , M7, and M8 when the first counter signal CNT1 matches the data from the pixel data memory. The inverse match signal MTCH2_B is pulled down by transistor groups illustrated by M9, M10, . . . , M11, and M12 when the second counter signal CNT2 matches the data from the pixel data memory. The counter signals may have a different offset in an odd subframe from an even subframe (e.g., for the even subframe in the first gray level, the CNT1 and CNT2 values may both be set to zero).

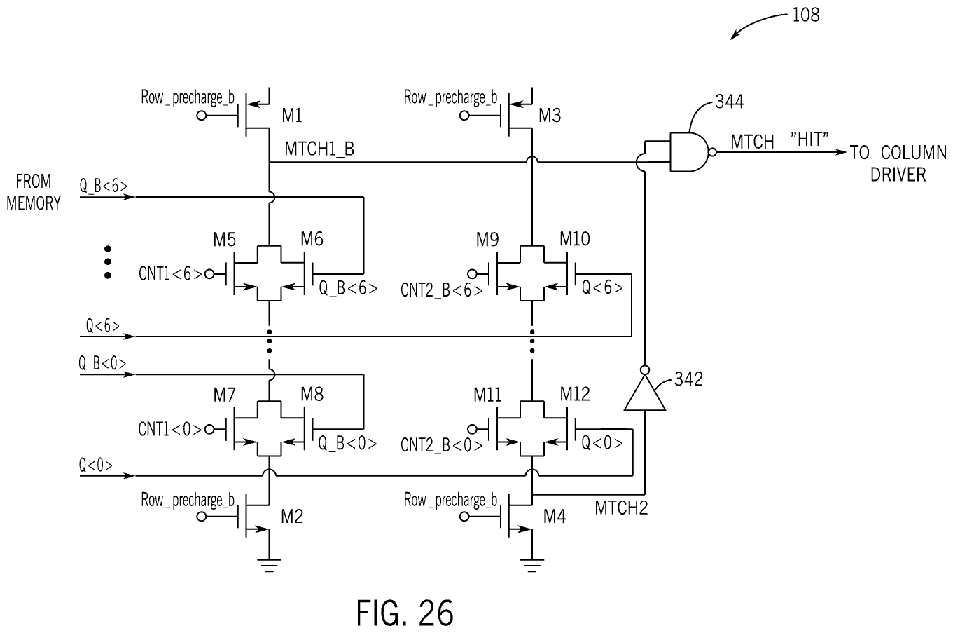

FIG. 26 provides another example of circuitry that may be included in a comparator 108 to carry out the pixel-level dithering illustrated in FIG. 24. The comparator 108 of FIG. 26 also compares two counter signals CNT1 and CNT2. Here, transistors M1, M2, M3, and M4 respectively pull up or pull down based on an inverse of a row precharge signal. A first inverse match signal MTCH1_B is connected to a first group of transistors arranged in series in OR-gates (e.g., transistors M5, M6, . . . , M7, M8). A second match signal MTCH2 may output from a second group of transistors arranged in series in OR-gates (e.g., transistors M9, M10, . . . , M11, M12). An inverter 342 may invert MTCH2 to produce MTCH2_B. The signals MTCH1_B and MTCH2_B may feed into a NAND gate 344. As in the example of FIG. 25, in the example of FIG. 26, the counter signals may have a different offset in an odd subframe from an even subframe (e.g., for the even subframe in the first gray level, the CNT1 and CNT2 values may both be set to zero).

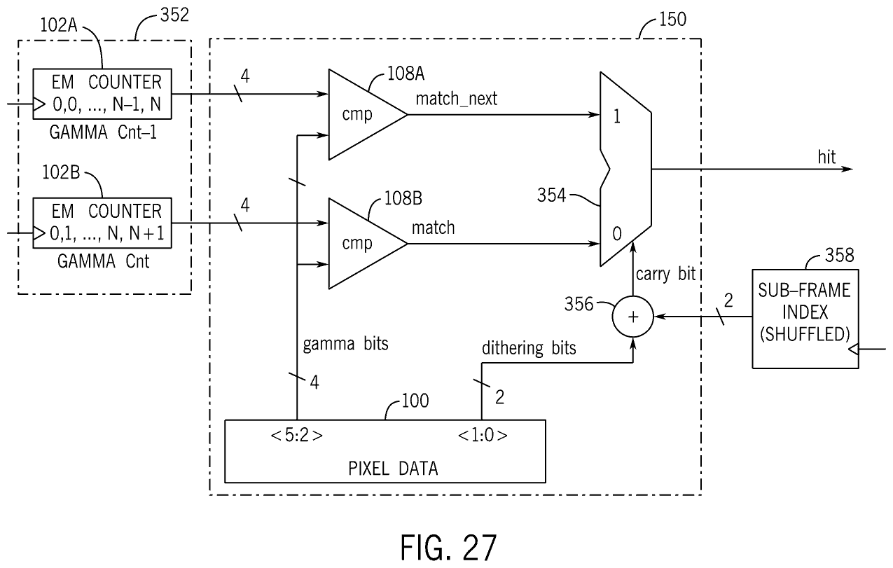

Pixel-level dithering may also make use of a carry-based approach. FIG. 27 provides on example of a carry-based core cell 150 that performs 2-bit subframe dithering using 6-bit data held in the pixel data memory 100. The four MSBs (<5:2>) may represent the gray level (e.g., encoding a gray level from 0 to 15) and the two LSBs (<1:0>) represent the dithering bits. A counter circuit 352 provides two counter signals output from two counters 102A and 102B, where the counter signal from the counter 102B is ahead of the counter signal from the counter 102A by one bit. Dual comparators 108A and 108B may generate respective match_next and match signals based on the counter signals. A multiplexer 354 may select from among the match_next and match signals to be a “hit” signal based on a carry bit. The carry bit may be output by addition circuitry 356, which may add the two dither bits to a 2-bit subframe number from a subframe index 358.

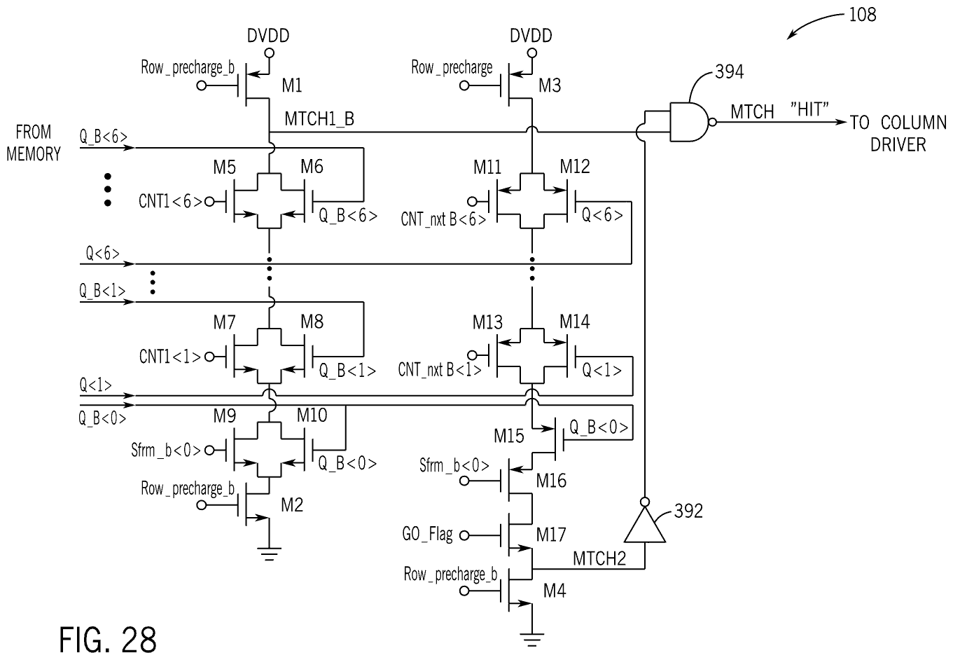

FIG. 28 provides another example of circuitry that may be included in a comparator 108 to implement carry-based pixel-level subframe dithering. Here, transistors M1, M2, M3, and M4 respectively pull up or pull down based on an inverse of a row precharge signal. A first inverse match signal MTCH1_B is connected to a first group of transistors arranged in series in OR-gates (e.g., transistors M5, M6, . . . , M7, M8, M9, M10). A second match signal MTCH2 may output from a second group of transistors arranged in series in OR-gates (e.g., transistors M11, M12, . . . , M13, M14) and transistors M15 and M16. An inverter 392 may invert MTCH2 to produce MTCH2_B. The signals MTCH1_B and MTCH2_B may feed into a NAND gate 394. Transistors M5, M6, M7, M8, M11, M12, M13, and M14 of FIG. 28 may operate in a similar way to transistors M5, M6, M7, M8, M9, M10, M11, and M12 of FIG. 26. In FIG. 28, however, transistors M9, M10, M15, M16, and M17 are included to effectively implement a multiplexer driven by the carry bit calculated from the sum of the dither bit and the subframe index. With this multiplexer, the branch comparing with CNT will only trigger if either there is no dithering (dither bit equal to 0) or there is no dithering in that frame, while the branch comparing with CNT_nxt will only trigger if there is a match in a situation in which the dither bit is 1, and the subframe index is also 1, making it a dithering subframe. A gray-level zero flag (G0_Flag) signal is coupled to a gate of the transistor M17 for situations where the pixel gray level is 0 (e.g., the G0_Flag signal is logically high when the pixel gray level is 0).

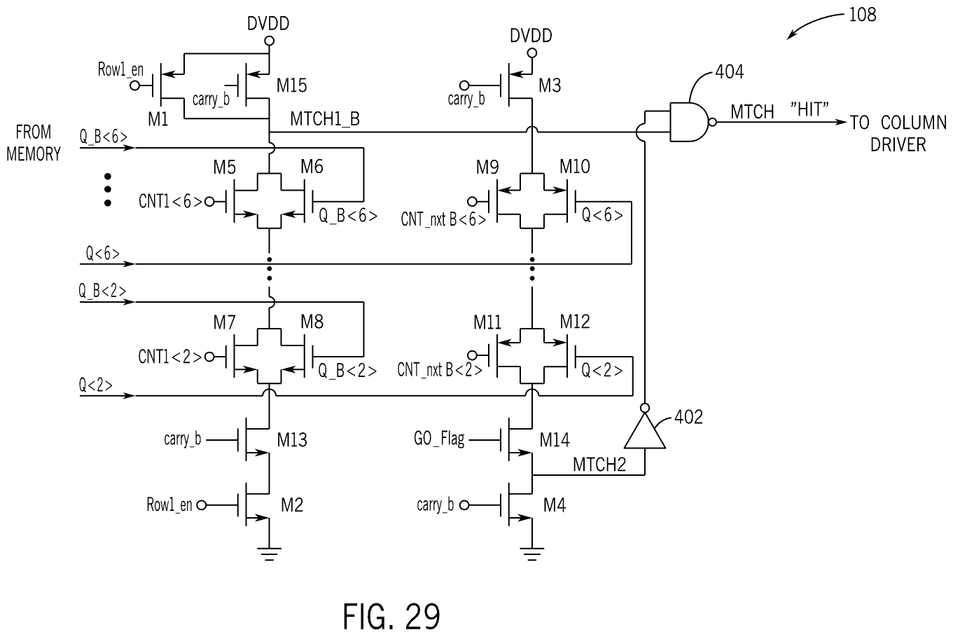

FIG. 29 provides another example of circuitry that may be included in a comparator 108 to implement carry-bit pixel-level subframe dithering using a precalculated carry bit. Here, transistors M1 and M15 form an OR gate to pull up based on a row enable or carry bit (carry_b). Transistor M2 pulls down based on the row enable signal. Transistor M3 pulls up based on the carry bit (carry_b). Transistor M4 pulls down based on the carry bit (carry_b). A first inverse match signal MTCH1_B is connected to a first group of transistors arranged in series in OR-gates (e.g., transistors M5, M6, . . . , M7, M8) in series with a transistor M13 coupled to a carry bit (carry_b). A second match signal MTCH2 may output from a second group of transistors arranged in series in OR-gates (e.g., transistors M9, M10, . . . , M11, M12) and a transistor M14 that is coupled to the gray-level zero flag (G0_Flag). An inverter 402 may invert MTCH2 to produce MTCH2_B. The signals MTCH1_B and MTCH2_B may feed into a NAND gate 404. Transistors M5, M6, . . . , M7, M8, M9, M10, . . . , M11, and M12 of FIG. 29 may operate in a similar way to transistors M5, M6, . . . , M7, M8, M9, M10, . . . , M11, and M12 of FIG. 26. In FIG. 29, however, transistors M13 and M4 are included that cause the “hit” signal to issue or not to issue based on a precalculated carry bit determined based on a subframe index and the dithering bits. In effect, the comparator 108 of FIG. 29 implements a carry bit multiplexer, in that the branch comparing with CNT will only trigger if the carry bit is low, while the branch comparing with CNT_nxt will only trigger if the carry bit is high, meaning that the subframe is a dithering subframe.

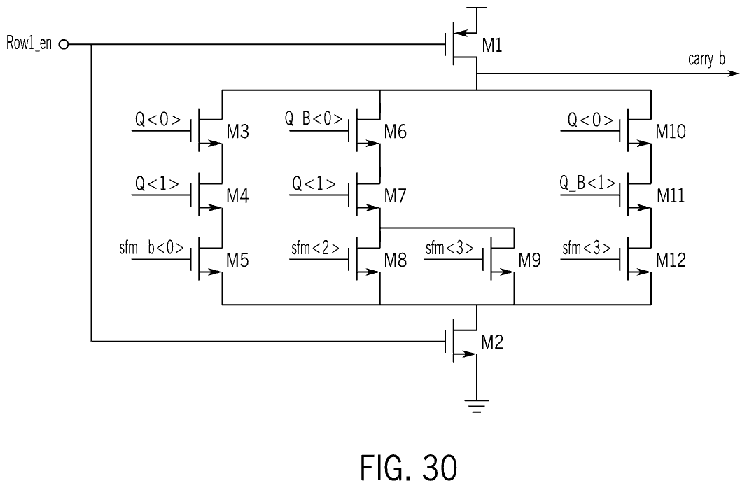

FIG. 30 is an example circuit that may be used to precalculate the carry bit signal used in the circuitry of FIG. 29, allowing the comparator 108 of FIG. 29 to implement carry-bit pixel-level subframe dithering. Here, a precalculated carry bit may be determined based on a number of subframe index bits (sfm) and data bits. Transistors M1 and M2 pull up and pull down, respectively, based on the row enable signal. Thus, the circuit of FIG. 30 may become operable when the row enable signal is high. NMOS transistors M3, M4, M5, M6, M7, M8, M9, M10, M11, and M12 are arranged as shown to generate the carry bit based on the subframe index bits (sfm) and data bits.

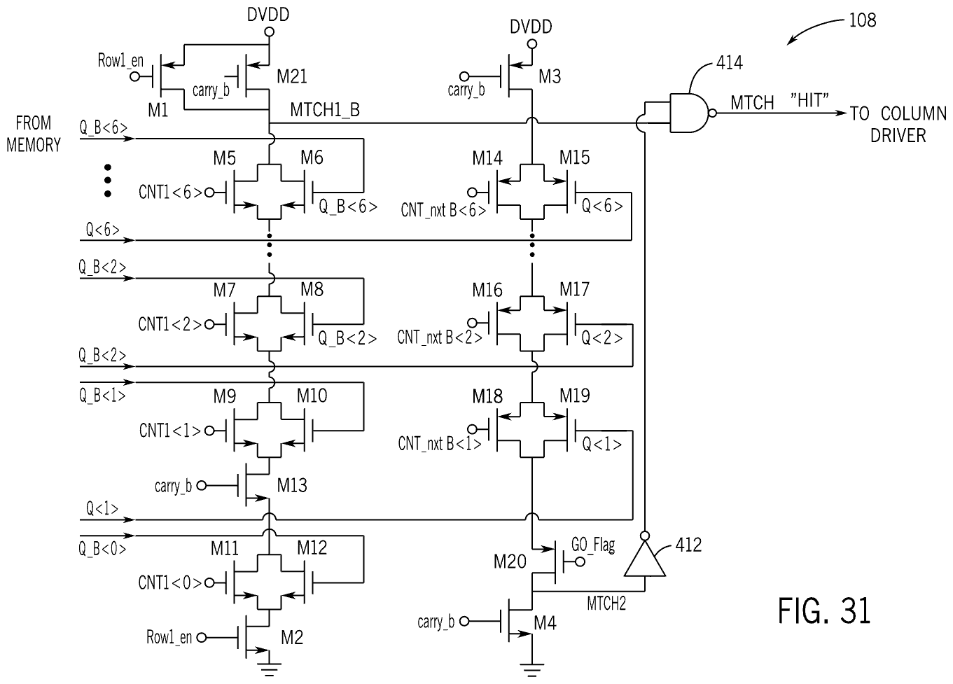

FIG. 31 provides another example of circuitry that may be included in a comparator 108 to implement carry-bit pixel-level subframe dithering using a precalculated carry-bit. Here, transistors M1 and M21 form an OR gate to pull up based on a row enable or carry bit (carry_b). Transistor M2 pulls down based on the row enable signal. Transistor M3 pulls up based on the carry bit (carry_b). Transistor M4 pulls down based on the carry bit (carry_b). A first inverse match signal MTCH1_B is connected to a first group of transistors arranged in series in OR-gates (e.g., transistors M5, M6, . . . , M7, M8, M9, M10, M11, M12) in series with a transistor M13. A second match signal MTCH2 may output from a second group of transistors arranged in series in OR-gates (e.g., transistors M14, M15, . . . , M16, M17, M18, M19) and a transistor M20. An inverter 412 may invert MTCH2 to produce MTCH2_B. The signals MTCH1_B and MTCH2_B may feed into a NAND gate 414. Transistors M5, M6, . . . , M7, M8, M9, M10, M11, M12, M14, M15, . . . , M16, M17, M18, and M19 of FIG. 31 may operate in a similar way to transistors M5, M6, . . . , M7, M8, M9, M10, . . . , M11, and M12 of FIG. 26. In FIG. 31, however, transistor M13 is included that causes the “hit” signal to issue or not to issue based on a precalculated carry bit (carry_b) determined based on a subframe index and the dithering bits. In effect, the comparator 108 of FIG. 31 implements a carry bit multiplexer, in that the branch comparing with CNT will only trigger if either there is no dithering (carry bit is 0) for that pixel in that subframe, while the branch comparing with CNT_nxt will only trigger if the carry bit is 1, signifying that there is dithering for that pixel in that subframe.

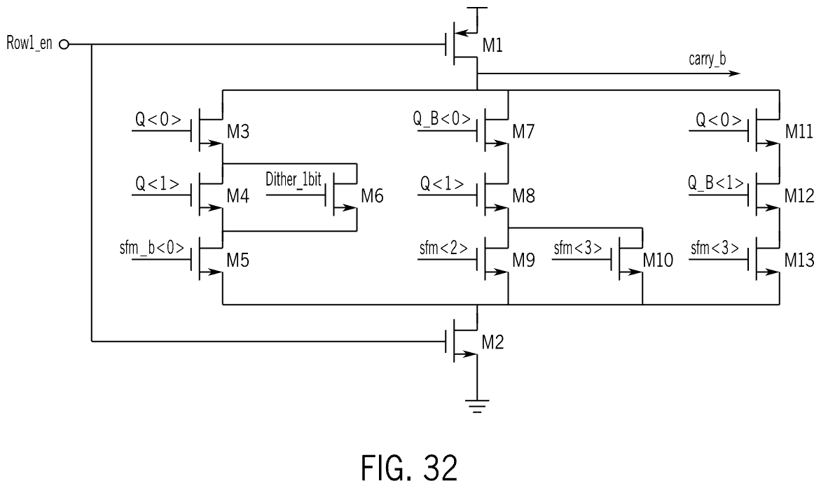

FIG. 32 is an example circuit that may be used to precalculate the carry bit signal used in the circuitry of FIG. 31, allowing the comparator 108 of FIG. 31 to implement carry-bit pixel-level subframe dithering. In FIG. 32, a precalculated carry bit may be determined based on a number of subframe index sfm bits and data bits. Transistors M1 and M2 pull up and pull down, respectively, based on the row enable signal. Thus, the circuit of FIG. 30 may become operable when the row enable signal is high. NMOS transistors M3, M4, M5, M6, M7, M8, M9, M10, M11, M12, and M13 are arranged as shown to generate the carry bit based on the subframe index sfm bits, data bits, and the newly added dithering mode control bit dither_1bit.

In combination, the circuitry of FIGS. 31 and 32 may offer tremendous flexibility. By trading area for flexibility, and using a smart control of the CNT, CNT_nxt, sfm and Dither_1bit signal, the circuitry of FIGS. 31 and 32 is flexible to offer full 6-bit data, 5-bit data+1-bit subframe dithering, and 4-bit data+2-bit subframe dithering. To achieve 6-bit data support using the circuitry of FIGS. 31 and 32, the signals may be selected as follows: sfm=0001 so that carry_b is always 1, selecting the full 6 bit comparator. Use CNT1 as expected for 6 bit. To achieve 5-bit data+1-bit dither using the circuitry of FIGS. 31 and 32, the signals may be selected as follows: CNT1<0>=1; sfm=000X where X goes between 1 and 0 for odd and even subframes; Dither_1bit=1. The signals CNT1<5:1> and CNT_nxt<5:1> may be used normally for 1-bit dithering. To achieve 4-bit data+2-bit dither using the circuitry of FIGS. 31 and 32, the signals may be selected as follows: CNT1<1:0>=11; CNT_nxt_b<1>=0; and Dither_1bit=0. The signals CNT1<5:2>, CNT_nxt<5:2> and sfm<3:0> may be used normally for 2-bit dithering.

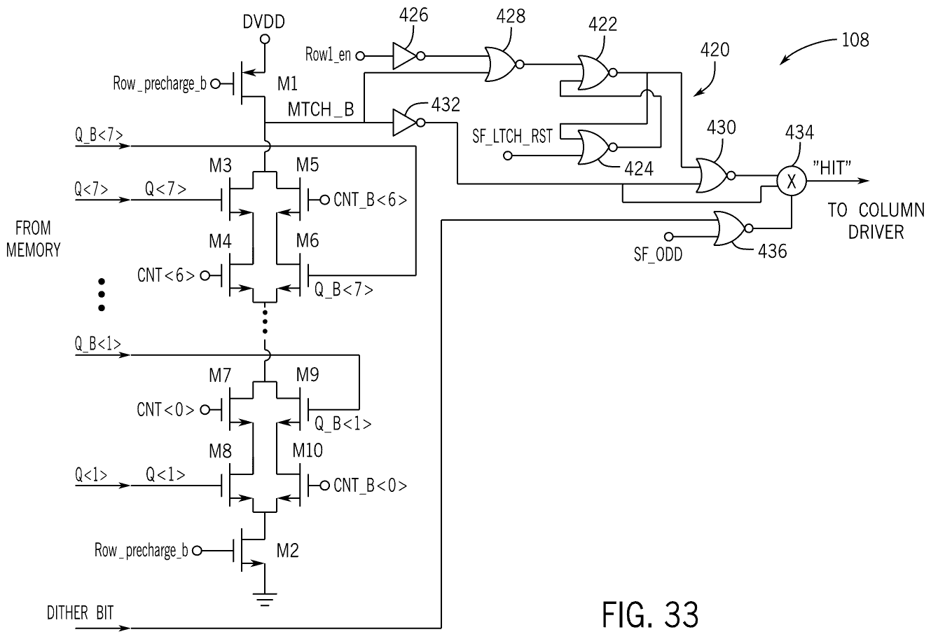

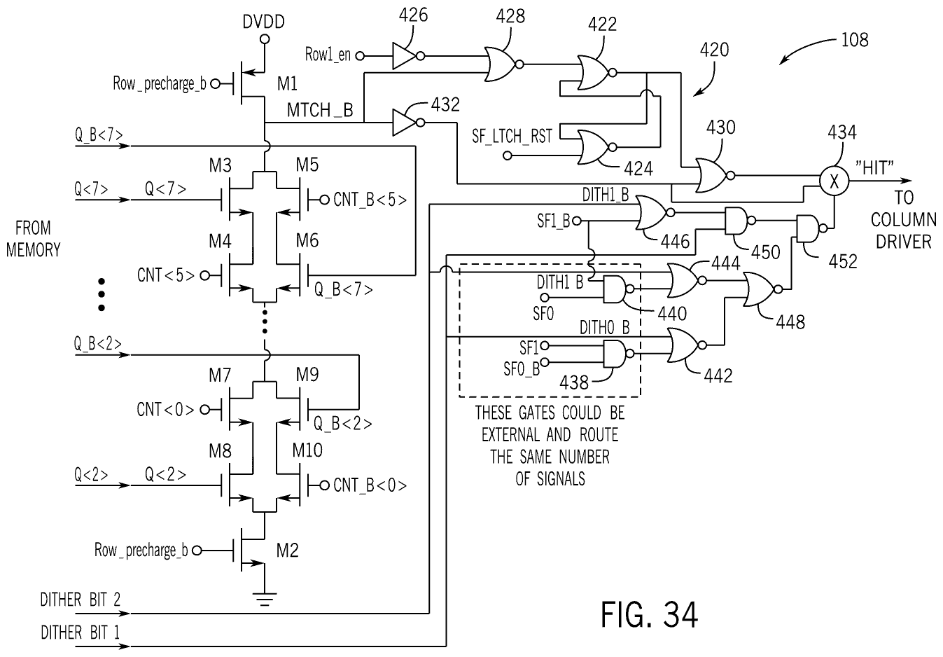

A comparator 108 of a core cell 150 may use a latch-based approach to perform 1-bit or multi-bit subframe dithering, as illustrated in FIGS. 33 and 34. FIG. 33 illustrates circuitry to perform 1-bit dithering using a latch 420 formed using NOR gates 422 and 424, and which may be reset via a subframe latch reset signal SF_LTCH_RST. Transistors M1 and M2 pull up and pull down, respectively, based on the row enable signal. An inverse match signal MTCH_B is connected to a group of transistors arranged in series in OR-gates (e.g., transistors M3, M4, M5, M6, . . . , M7, M8, M9, M10) in series. An inverter 426 may invert the row enable signal and provide it to a NOR gate 428 along with the inverse match signal MTCH_B. The output of the NOR gate 428 is subsequently stored in the latch 420. The value from the latch 420 may be compared in a NOR gate 430 that also receives a match signal MTCH (e.g., an inverse of the inverse match signal MTCH_B) from an inverter 432, so that the output of the NOR gate 430 is 1 if the latch has been previously triggered but the comparator 108 is currently reporting no such match. A multiplexer 434 may select between the value of the NOR gate 430 and the match signal MTCH to output as a “hit” signal based on a selection signal from a NOR gate 436. The NOR gate 436 may receive the value of a dither bit from the memory and a subframe odd signal SF_ODD (e.g., which indicates that the present subframe is an odd subframe).

Using the circuitry of FIG. 33, only one gray level is read out, but there is an extra signal indicating the subframe, which changes the behavior of the circuit. The subframe odd signal SF_ODD goes high if the subframe is odd and low if it is even. The subframe latch reset signal SF_LTCH_RST resets the latch at the beginning of each subframe. Note that the LSB is the dither bit and it is treated differently, while the comparator only acts on the pixel data bits.

In the odd subframes, if the comparator 108 matches, the pixel is turned off right away. In the even subframes, the first time the comparator 108 matches, the output of the logic is still zero, but the latch 420 changes state to 1. Then, in the next gray level, because the comparator 108 output is low, but the latch 420 is high, the logic outputs a match. This way, in the even subframes, the gray level of the pixel is extended by one gray level. Note that this implementation of 1-bit dithering may use only one counter signal CNT bus at the cost of more area in the comparator 108.

FIG. 34 represents an extension of the circuitry of FIG. 33 to perform 2-bit dithering. As such, a description of like elements may be found in the description of FIG. 33. FIG. 34 includes selection logic to control the multiplexer 434 based on the additional dither bit used in the example of FIG. 34. Subframe number signals SF0, SF1 represent SF<1:0> representing the subframe number (e.g., assuming four subframes in this 2-bit dithering example). The _B signals are the inverted versions. A NAND gate 438 receives subframe number signals SF0_B and SF1 and a NAND gate 440 receives subframe number signals SF1_B and SF0. Note that the NAND gates 438 and 440 may be located externally to the comparator 108 in some embodiments. A NOR gate 442 receives the output of the NAND gate 438 and an inverse of the first dither bit DITH0_B, a NOR gate 444 receives the output of the NAND gate 440 and an inverse of the second dither bit DITH1_B, and a NOR gate 446 receives the inverse of the second dither bit DITH1_B and a subframe number signal SF1_B. A NOR gate 448 receives the output of the NOR gates 442 and 444 and an AND gate 450 receives the inverse of the first dither bit DITH0_B and the output of the NOR gate 446. A NAND gate 452 then receives the output of the NOR gate 448 and the NAND gate 450 as inputs and outputs a selection signal to control the multiplexer 434. Note that the two LSB's are the dither bits and they are treated differently, while the comparator 108 only acts on the pixel data bits. Note that this implementation of 2-bit dithering may use only one counter signal CNT bus at the cost of more area.

Using the circuitry of FIG. 34, if the dithering bits <1:0> are 0 there is no dithering. If they are 1, only the last subframe has a longer pulse. If they are 2, all even subframes have a longer pulse. If they are 3 all subframes except the first one have a longer pulse. In the subframes that, according to the dithering bits, a regular pulse should happen, the “hit” signal output goes high when the MTCH signal goes high. In the subframes where a longer pulse is expected, when the MTCH signal goes high, the “hit” signal of the logic output remains low, but the latch 420 changes state, and in the next gray level, if the MTCH signal output is low but the latch 420 is high, the logic outputs a high “hit” signal.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic display comprising:
a pixel active array; and
content-addressable memory configured to selectively control the pixel active array.

2. The electronic display of claim 1, wherein display pixels of the pixel active array comprise:
a 1-bit memory coupled to a column line that carries a control signal issued by the content-addressable memory;
a switch controlled by the 1-bit memory;
a current source configured to selectively provide a current based on a state of the switch; and
a light-emissive element configured to emit light based on the current.

3. The electronic display of claim 2, wherein the light-emissive element comprises a light-emitting diode (LED).

4. The electronic display of claim 2, wherein the 1-bit memory is configured to be enabled to be programmed by the control signal by a row write enable signal synchronized to a row enable signal of the content-addressable memory.

5. The electronic display of claim 1, wherein display pixels of the pixel active array are configured to turn on and remain on until receiving a control signal from the content-addressable memory to turn off.

6. The electronic display of claim 1, wherein the content-addressable memory comprises an array of core cells configured to store image data corresponding to an array of display pixels of the pixel active array and to selectively turn off the display pixels of the pixel active array based on the stored image data.

7. The electronic display of claim 6, wherein the array of core cells is equal in number to the display pixels of the pixel active array.

8. The electronic display of claim 1, wherein the content-addressable memory comprises an array of core cells, wherein each core cell comprises:
pixel data memory configured to store digital image data corresponding to one display pixel of the pixel active array;
a comparator configured to output a control signal to the one display pixel to turn off based on a match between the digital image data and a counter based on a gray level pulse width; and
column driver circuitry configured to propagate the control signal to column driver circuitry of another core cell or the pixel active array.

9. The electronic display of claim 8, wherein the comparator comprises:
a dynamic OR-based comparator;
a dynamic AND-based comparator; or
a static comparator.

10. The electronic display of claim 9, wherein the comparator comprises circuitry configured to implement subframe dithering.

11. The electronic display of claim 8, wherein the column driver circuitry comprises:
a dynamic column driver;
a static column driver;
an analog serial complementary metal-oxide-semiconductor multiplexer (CMOS-mux)-based column driver; or
a digital multiplexer-based column driver.

12. A method for controlling an electronic display comprising:
reading pixel data corresponding to pixel data of a display pixel in a pixel active area of the electronic display from a memory located outside of the pixel active area into a comparator located outside of the pixel active area;
comparing the pixel data to a counter value corresponding to a gray level using the comparator, wherein:
when the counter value does not correspond to the pixel data, the comparator outputs a control signal in a first state to a column driver located outside of the pixel active area; and
when the counter value corresponds to the pixel data, the comparator outputs the control signal in a second state different from the first state to the column driver located outside of the pixel active area;
propagating the control signal to the pixel active area using the column driver; and
switching the display pixel to turn off in response to the control signal being in the second state.

13. The method of claim 12, wherein the method is performed for each gray level of each subframe of each frame displayed on the electronic display.

14. The method of claim 13, wherein every frame comprises a plurality of subframes.

15. The method of claim 13, wherein the method is performed pixel-row-by-pixel-row.

16. An electronic device comprising:
data processing circuitry configured to generate pixel data for a plurality of display pixels; and
an electronic display comprising:
a pixel active array comprising the plurality of display pixels; and
a plurality of control cells each corresponding to one respective display pixel of the pixel active array, wherein each control cell comprises:
pixel data memory configured to store pixel data for the respective display pixel corresponding to its respective display pixel;
a comparator configured to generate a control signal based on a comparison between the pixel data and a counter corresponding to a gray level; and
a column driver configured to propagate the control signal to the pixel active array.

17. The electronic device of claim 16, wherein the plurality of control cells are configured to operate pixel-row-by-pixel-row.

18. The electronic device of claim 16, wherein the comparator comprises:
a dynamic OR-based comparator;
a dynamic AND-based comparator; or
a static comparator.

19. The electronic device of claim 16, wherein the comparator comprises circuitry configured to implement subframe dithering.

20. The electronic device of claim 16, wherein the column driver circuitry comprises:
a dynamic column driver;
a static column driver;
an analog serial complementary metal-oxide-semiconductor multiplexer (CMOS-mux)-based column driver; or
a digital multiplexer-based column driver.
